(19) United States
(12) Patent Application Publication
(10) Pub. No.: US 2012/0127330 A1
(43) Pub. Date: May 24, 2012

(54) IMAGE PICKUP DEVICE

(75) Inventors: Kengo Masaoka, Higashiosaka City (JP); Akihiro Maenaka, Kadoma City (JP); Haruo Hatanaka, Kyoto City (JP)

(73) Assignee: SANYO ELECTRIC CO., LTD., Osaka (JP)

(21) Appl. No.: 13/387,993

(22) PCT Filed: Jul. 27, 2010
(86) PCT No.: PCT/JP2010/062596

§ 371 Date: Jan. 30, 2012

(30) Foreign Application Priority Data
Jul. 28, 2009 (JP) 2009-175622
Jul. 22, 2010 (JP) 2010-165164

(51) Int. Cl. H04N 5/228; H04N 5/76; H04N 5/262; H04N 5/235; H04N 5/217

(52) U.S. Cl. 348/208.4; 348/362; 348/241; 348/240.99; 348/231.99; 348/E05.037; 348/E05.055; 348/E05.031

(57) ABSTRACT

Provided is an image pickup device that enables distortion compensation with high precision. Exposure and reading are conducted on pixel rows that are discontinuous with respect to a vertical direction of an image pickup element, and multiple low resolution images are obtained. Each of these multiple low resolution images has a lower distortion than an ordinary image obtained by conducting an ordinary continuous exposure and reading. Therefore, output images with reduced distortion can be generated by using the low resolution images.

### TECHNICAL FIELD

The present invention relates to an image pickup device equipped with an XY address type image pickup element such as a complementary metal oxide semiconductor (CMOS) image sensor.

### BACKGROUND ART

Recent years, image pickup devices equipped with an XY address type image pickup element such as a CMOS image sensor are widely used. The XY address type image pickup element can perform exposure and reading by designating an arbitrary pixel. However, on the other hand, it is necessary to perform exposure and reading sequentially, and it is difficult to perform the exposure for all pixels simultaneously. Therefore, in the XY address type image pickup element, there occurs a problem of distortion due to timing shifts of exposure and reading for pixels, which is called a focal plane distortion (hereinafter may also be referred to simply as “distortion”).

This focal plane distortion is described specifically with reference to drawings. FIG. 28 is a diagram illustrating a focal plane distortion, and FIG. 29 is a timing chart illustrating exposure timing and read timing when image illustrated in FIG. 28 is photographed. FIGS. 28 and 29 illustrate an image pickup element that performs exposure and signal output in order from an upper pixel row to a lower pixel row in a vertical direction (up and down direction in FIGS. 28 and 29) when one image is photographed.

Left side diagrams of FIG. 28 illustrate imaging regions (angles of view) 101 to 106 when pixel rows 111 to 116 are exposed, and right diagram illustrates an image 120 generated by imaging. Note that FIG. 28 illustrates a distortion when subjects T1 and T2 are standing still and the image pickup device is panned to the left at a uniform speed during photographing of the image 120 (in a period from start of exposure of the uppermost pixel row 111 until end of exposure of the lowermost pixel row 116).

A vertical axis of FIG. 29 represents a position of the image pixel row in the vertical direction, and a horizontal axis represents time. Exposure periods of pixel rows are illustrated by thick lines, and it is supposed that a pixel signal of the pixel row is read at the end of the exposure period. Note that FIG. 29 illustrates a case where a moving image is photographed (namely, frame images are sequentially taken), and one frame period is a period from reading of a pixel signal of the uppermost pixel row 111 of a frame until reading of a pixel signal of the uppermost pixel row 111 of the next frame.

As illustrated in FIGS. 28 and 29, when the image pickup device moves, because the exposure timing is different among the pixel rows 111 to 116, positions of the subjects T1 and T2 are respectively different among the imaging regions 101 to 106 at the individual timings. In particular, if the image pickup device is panned in one direction as this example, positions of the subjects T1 and T2 in the imaging regions 101 to 106 move in the opposite direction (right direction in this example) to the panning direction (left direction in this example) as the exposure timing is delayed. Therefore, the image 120 obtained by the photographing has a distortion in which a lower pixel with later exposure timing is moved more in the direction opposite to the panning direction.

The problem of the focal plane distortion is not limited to a case where the image pickup device is intentionally and largely moved like a case of panning or tilting the image pickup device. For instance, when the image pickup device is moved accidentally and slightly by shake or the like, the imaging region may move largely if a zoom magnification is high. Then, the distortion increases, and it may become a problem. In addition, the focal plane distortion occurs not only in a case where the image pickup device is moved, but also in a case where the subject is moved. Note that when the subject is moved, a distorted image is obtained in which a pixel of later exposure timing is moved more in the same direction as the movement of the subject.

The focal plane distortion described above can be canceled by equalizing the exposure timing (namely, by equalizing the exposure timing among the pixel rows of FIG. 29). For instance, the equalization of the exposure timing can be realized by using a mechanical shutter or adopting a global shutter method with an interline structure. In addition, it is also possible to decrease a time difference of the exposure timing among pixel rows (namely, to decrease exposure timing shifts among pixel rows of FIG. 29) by increasing sampling speed with respect to an output signal so that a read timing interval of the pixel rows is shortened.

However, if an additional structure such as a mechanical shutter is used, the structure of the image pickup device may be upsized and complicated, and cost may be increased. In addition, if the structure is changed to adopt the global shutter method for imaging, noise level may increase so that signal-to-noise ratio (S/N) may be deteriorated, or other problem may occur. On the other hand, if the sampling speed is increased, higher processing of the image pickup device may be required or the structure thereof may be complicated, and cost may increase.

Therefore, for example, Patent literatures 1 and 2 propose an image pickup device that compensates a distortion by image processing. Specifically, a plurality of images obtained by photographing are compared so that a movement generated in an image to be corrected is estimated, and the correction is performed by giving an image to be processed a distortion in the opposite direction to the distortion due to the estimated movement. With this structure, the distortion can be reduced by a simple structure without using the above-mentioned special structure.

### PRIOR ART DOCUMENTS

### Patent Documents

Patent Document 1: JP-A-2006-054788
Patent Document 2: JP-A-2007-208580

### DISCLOSURE OF THE INVENTION

### Problem to be Solved by the Invention

In the image pickup device proposed in Patent literatures 1 and 2, the image in which a movement is detected may have a large movement. In this case, even if it is attempted to estimate the movement and to correct the distortion, misdetection of movement or miscorrection of image may occur easily so that it becomes difficult to compensate the distortion with high precision. This is a problem.

Therefore, an object of the present invention is to provide an image pickup device that enables distortion compensation with high precision.

### Means for Solving the Problem

In order to achieve the above-mentioned object, an image pickup device according to the present invention includes an image pickup element that can perform exposure and reading by designating arranged arbitrary pixels, a scan control portion that controls exposure and reading of pixels of the image pickup element, and a signal processing portion that generates an output image. The scan control portion performs the exposure and reading discontinuously on pixels arranged in a predetermined direction of the image pickup element so as to generate a low resolution image, and the signal processing portion generates the output image based on the low resolution image.

In addition, in the image pickup device having the above-mentioned structure, the scan control portion may perform the exposure and reading of pixels by sequentially switching a plurality of pixel groups having different pixel positions so as to sequentially generate a plurality of low resolution images, and the signal processing portion may generate one output image based on the plurality of low resolution images.

With this structure, the output image is generated using the low resolution images having different pixel positions. Therefore, it is possible to suppress deterioration of resolution of the output image generated by using the low resolution image.

In addition, in the image pickup device having the above-mentioned structure, the image pickup element may include pixels arranged in the horizontal direction and in the vertical direction, and the pixel group may include two or more adjacent pixels in the vertical direction and in the horizontal direction.

With this structure, if the image pickup element has the Bayer arrangement, this pixel and adjacent pixels include RGB pixel values. Therefore, when calculating a new pixel value such as a luminance value, for example, pixel values of the pixel and the adjacent pixels may be used so that high precision calculation can be performed.

In addition, in the image pickup device having the above-mentioned structure, the image pickup element may includes pixels arranged in the horizontal direction and in the vertical direction, and the pixel group may include pixels that are discontinuously adjacent in the vertical direction and are continuously adjacent in the horizontal direction, and the scan control portion may control the exposure and reading of each of the pixels arranged in the horizontal direction.

In addition, the image pickup device having the above-mentioned structure may further include a lens portion having a variable zoom magnification, and the scan control portion may determine positions of pixels to be exposed and read for generating the low resolution image in accordance with the zoom magnification of the lens portion.

With this structure, it is possible to change the positions of pixels to be exposed and read in accordance with a zoom magnification, namely amplitude of distortion that can be generated. In particular, if the zoom magnification is large and it is expected that a large distortion will occur, it is possible to perform the exposure and reading of pixels having a positional relationship such that an effect of distortion compensation is enhanced (for example, an interval between pixels that are not adjacent is large).

In addition, the image pickup device having the above-mentioned structure may further includes a memory that temporarily store a plurality of low resolution images, and a memory control portion that controls reading of the low resolution images from the memory to the signal processing portion. The memory control portion may set an order of reading pixel signals of the low resolution images stored in the memory to be correspond to a pixel arrangement of the image pickup element from which the pixel signals are obtained.

With this structure, only by reading the pixel signals from the memory to the signal processing portion, the pixel signals can be read out in accordance with the original arrangement of the image pickup element. Therefore, only by correcting positions of the read-out pixel signals by the signal processing portion, it is possible to generate the output image with high resolution and corrected distortion. Note that it is possible that when the pixel signal is supplied to the signal processing portion, a certain correction has been already performed by changing reading positions for reading the memory.

In addition, the image pickup device having the above-mentioned structure may further includes a motion detection portion that detects a motion among a plurality of low resolution images by comparing the plurality of low resolution images, and the signal processing portion may correct relative positional relationship among the plurality of low resolution images for combining so that the motion detected by the motion detection portion becomes small, so as to generate the output image.

With this structure, it is possible to cancel distortion generated among the multiple low resolution images for combining. Therefore, it is possible to correct the distortion with higher precision, which is generated in the output image obtained by combining the low resolution images.

In addition, the image pickup device according to the present invention includes an image pickup element that can perform exposure and reading by designating arranged arbitrary pixels, a scan control portion that controls exposure and reading of pixels of the image pickup element, a signal processing portion that generates an output image, and a lens portion having a variable zoom magnification. When the zoom magnification is a predetermined value or larger, the scan control portion performs the exposure and reading discontinuously on pixels arranged in a predetermined direction of the image pickup element so as to generate a low resolution image, and the signal processing portion generates the output image based on the low resolution image. When the zoom magnification is smaller than the predetermined value, the scan control portion performs the exposure and reading continuously on the pixels arranged in the predetermined direction of the image pickup element so as to generate an ordinary image, and the signal processing portion generates the output image based on the ordinary image.

With this structure, if the zoom magnification is smaller than the predetermined value and it is expected only a small distortion will occur, the output image is generated based on the ordinary image obtained by performing the exposure and reading on pixels arranged continuously. Therefore, it is possible to suppress that the output image is distorted by wrong distortion compensation or that resolution of the output image is deteriorated.

### Effects of the Invention

With the structure of the present invention, the exposure and reading are performed discontinuously on pixels arranged in a predetermined direction, and hence it is possible to obtain the low resolution image with smaller distortion than the image obtained by performing the exposure and reading continuously. Therefore, by using this low resolution image, it is possible to generate an output image in which distortion is reduced with high precision.

### BRIEF DESCRIPTION OF THE DRAWINGS

FIG. 1 is a block diagram illustrating the entire structure of an image pickup device according to an embodiment of the present invention.

FIG. 2 is a block diagram illustrating a structure of a main part of the image pickup device capable of performing distortion compensation of a first example.

FIG. 3 is a diagram of a pixel portion illustrating a pixel arrangement and one example of an exposure and reading pattern for reducing distortion.

FIG. 4 is a timing chart illustrating exposure timing and read timing when exposure and reading is performed using the exposure and reading pattern for reducing distortion illustrated in FIG. 3.

FIG. 5 is a diagram illustrating one example of an imaging region.

FIG. 6 is a diagram illustrating a low resolution image obtained by performing exposure and reading using the exposure and reading pattern for reducing distortion.

FIG. 7 is a diagram illustrating an ordinary image obtained by performing exposure and reading using an ordinary exposure and reading pattern.

FIG. 8 is a diagram illustrating a low resolution image obtained by performing exposure and reading using the exposure and reading pattern for reducing distortion.

FIG. 9 is a block diagram illustrating a structure of a main part of the image pickup device capable of performing distortion compensation of a second example.

FIG. 10 is a diagram illustrating one example of a combined image.

FIG. 11 is a diagram illustrating one example of a process of correcting pixel row positions of the combined image.

FIG. 12 is a diagram illustrating one example of a corrected combined image obtained by correcting pixel row positions of the combined image illustrated in FIG. 10.

FIG. 13 is a diagram illustrating a specific example of a correction method using template matching.

FIG. 14 is a diagram illustrating a specific example of the correction method using the template matching.

FIG. 15 illustrates a correction method of further correcting the corrected target pixel rows obtained in FIG. 13, by the sub pixel.

FIG. 16 illustrates a correction method of further correcting the corrected target pixel rows obtained in FIG. 14, by the sub pixel.

FIG. 17 is a diagram of a pixel portion illustrating the pixel arrangement and a first other example of the exposure and reading pattern for reducing distortion.

FIG. 18 is a timing chart illustrating exposure timing and read timing when exposure and reading is performed using the exposure and reading pattern for reducing distortion illustrated in FIG. 17.

FIG. 19 is a diagram illustrating a low resolution image obtained by performing exposure and reading using the exposure and reading pattern for reducing distortion of the first other example.

FIG. 20 is a diagram illustrating a low resolution image obtained by performing exposure and reading using the exposure and reading pattern for reducing distortion of the first other example.

FIG. 21 is a diagram illustrating one example of a combined image obtained by combining the low resolution images obtained using the exposure and reading pattern for reducing distortion of the first other example.

FIG. 22 is a diagram illustrating one example of a corrected combined image obtained by correcting pixel row positions of the combined image illustrated in FIG. 21.

FIG. 23 is a diagram of a pixel portion illustrating the pixel arrangement and a second other example of the exposure and reading pattern for reducing distortion.

FIG. 24 is a timing chart illustrating exposure timing and read timing when exposure and reading is performed using the exposure and reading pattern for reducing distortion illustrated in FIG. 23.

FIG. 25 is a diagram illustrating a low resolution image obtained by performing exposure and reading using the exposure and reading pattern for reducing distortion of the second other example.

FIG. 26 is a diagram illustrating a low resolution image obtained by performing exposure and reading using the exposure and reading pattern for reducing distortion of the second other example.

FIG. 27 is a diagram illustrating one example of the corrected combined image obtained by combining the low resolution images obtained using the exposure and reading pattern for reducing distortion of the second other example.

FIG. 28 is a diagram illustrating a focal plane distortion.

FIG. 29 is a timing chart illustrating exposure timing and read timing when image illustrated in FIG. 28 is photographed.

FIG. 30 is a diagram illustrating frame sequence that is output when the ordinary exposure and reading pattern is switched to the exposure and reading pattern for reducing distortion.

FIG. 31 is a diagram illustrating the frame sequence that is output when the exposure and reading pattern for reducing distortion is switched to the ordinary exposure and reading pattern.

FIG. 32 is a diagram illustrating an example of a method of replacing an invalid frame with a combined frame by the exposure and reading pattern for reducing distortion.

FIG. 33 is a diagram illustrating an example of a method of calculating a motion vector between the low resolution images.

### IMAGE PICKUP DEVICE

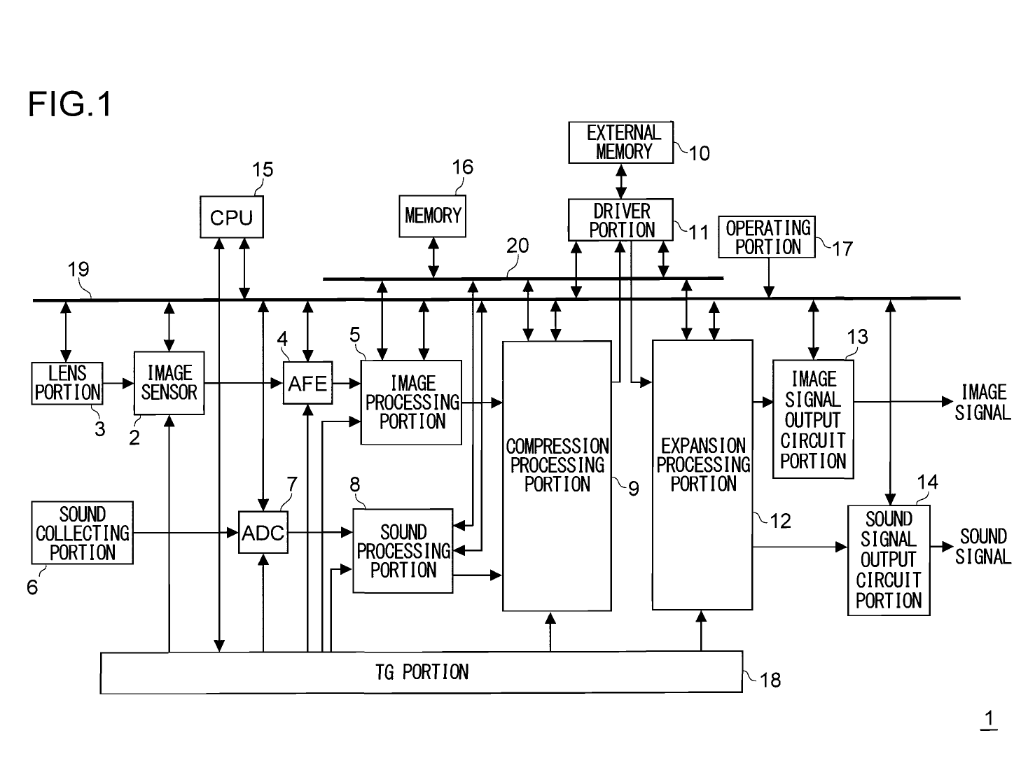

First, the entire structure of an image pickup device according to this embodiment is described with reference to FIG. 1. FIG. 1 is a block diagram illustrating the entire structure of the image pickup device according to the embodiment of the present invention.

As illustrated in FIG. 1, the image pickup device 1 includes an image sensor 2 constituted of an XY address type solid-state image pickup element such as a CMOS image sensor that converts an incident optical image into an electrical signal, and a lens portion 3 that forms an optical image of a subject on the image sensor 2 and adjusts light intensity and the like. The lens portion 3 and the image sensor 2 constitute an imaging portion, and the imaging portion generates an image signal. Note that the lens portion 3 includes various lenses (not shown) such as a zoom lens and a focus lens, an aperture stop (not shown) that adjusts light intensity entering the image sensor 2.

Further, the image pickup device 1 includes an analog front end (AFE) 4 that converts an image signal as an analog signal output from the image sensor 2 into a digital signal and adjusts a gain, an image processing portion 5 that performs various image processing such as a gradation correction process on the digital image signal output from the AFE 4, a sound collecting portion 6 that converts input sound into an electrical signal, an analog to digital converter (ADC) 7 that converts a sound signal as an analog signal output from the sound collecting portion 6 into a digital signal, a sound processing portion 8 that performs various sound processing such as noise reduction on a sound signal output from the ADC 7 and outputs the result, a compression processing portion 9 that performs a compression encoding process for moving images such as Moving Picture Experts Group (MPEG) compression method on the image signal output from the image processing portion 5 and the sound signal output from the sound processing portion 8 and performs a compression encoding process for still images such as Joint Photographic Experts Group (JPEG) compression method on the image signal output from the image processing portion 5, an external memory 10 for recording an compression encoded signal that is compression-encoded by the compression processing portion 9, a driver portion 11 that records and reads the compression encoded signal in or from the external memory 10, and an expansion processing portion 12 that expands and decodes the compression encoded signal read out by the driver portion 11 from the external memory 10.

In addition, the image pickup device 1 includes an image signal output circuit portion 13 that converts an image signal obtained by decoding in the expansion processing portion 12 into an analog signal for displaying on a display device such as a display monitor (not shown), and a sound signal output circuit portion 14 that converts a sound signal obtained by decoding in the expansion processing portion 12 into an analog signal for reproducing in a reproduction device such as a speaker (not shown).

In addition, the image pickup device 1 includes a central processing unit (CPU) 15 that controls the entire action of the image pickup device 1, a memory 16 for storing programs for performing the processes and temporarily storing data when the programs are executed, an operating portion 17 including a button for starting photographing and a button for adjusting photographing conditions to which user's instructions are input, a timing generator (TG) portion 18 that outputs timing control signals for synchronizing action timings of the individual portions, a bus 19 for communicating data between the CPU 15 and each block, and a bus 20 for communicating data between the memory 16 and each block. Note that the buses 19 and 20 are omitted in the following description concerning communication of each block for simple description.

Note that the image pickup device 1 capable of generating image signals of moving images and still images is described as one example, but the image pickup device 1 may have a structure capable of generating only image signals of still images. In this case, it is possible to adopt a structure without the sound collecting portion 6, the ADC 7, the sound processing portion 8, the sound signal output circuit portion 14, and the like.

In addition, the external memory 10 may be any type as long as it can record image signals and sound signals. For instance, a semiconductor memory such as a Secure Digital (SD) card, an optical disc such as a DVD, and a magnetic disk such as a hard disk can be used as this external memory 10. In addition, the external memory 10 may be removable from the image pickup device 1.

Next, the entire action of the image pickup device 1 is described with reference to FIG. 1. First, the image pickup device 1 obtains an image signal as an electrical signal when the image sensor 2 performs photoelectric conversion of light entering through the lens portion 3. Then, the image sensor 2 outputs the image signal to the AFE 4 at a predetermined timing in synchronization with a timing control signal supplied from the TG portion 18.

Then, the image signal that is converted from the analog signal to the digital signal by the AFE 4 is supplied to the image processing portion 5. The image processing portion 5 converts the input image signal having red (R), green (G), and blue (B) color signal components into an image signal having a luminance signal component (Y) and a color difference signal components (U, V), and performs various image processing such as gradation correction and edge enhancement. In addition, the memory 16 works as a frame memory, which temporarily stores the image signal when the image processing portion 5 performs the process.

In addition, based on the image signal supplied to the image processing portion 5 on this occasion, the lens portion 3 adjusts positions of various lenses for performing focus adjustment and adjusts an opening degree of the aperture stop for performing exposure adjustment. Each adjustment of the focus and the exposure is performed automatically based on a predetermined program or manually based on a user's instruction to be an optimal state.

When an image signal of the moving image is generated, the sound collecting portion 6 performs sound collecting. The sound signal, which is collected by the sound collecting portion 6 and is converted into an electrical signal, is supplied to the sound processing portion 8. The sound processing portion 8 converts an input sound signal into a digital signal and performs various sound processing such as noise reduction and sound signal level control. Then, the image signal output from the image processing portion 5 and the sound signal output from the sound processing portion 8 are both supplied to the compression processing portion 9 and are compressed by a predetermined compression method in the compression processing portion 9. In this case, the image signal and the sound signal are associated with each other in a temporal manner so that the image and the sound are not deviated from each other in reproduction. Then, the compression encoded signal output from the compression processing portion 9 is recorded in the external memory 10 via the driver portion 11.

On the other hand, when the image signal of still image is generated, the image signal output from the image processing portion 5 is supplied to the compression processing portion 9 and is compressed by a predetermined compression method in the compression processing portion 9. Then, the compression encoded signal output from the compression processing portion 9 is recorded in the external memory 10 via the driver portion 11.

The compression encoded signal of the moving image recorded in the external memory 10 is read out by the expansion processing portion 12 based on a user's instruction. The expansion processing portion 12 expands and decodes the compression encoded signal so as to generate and output the image signal and the sound signal. Then, the image signal output circuit portion 13 converts the image signal output from the expansion processing portion 12 into a form that can be displayed on the display device and outputs the result. The sound signal output circuit portion 14 converts the sound signal output from the expansion processing portion 12 into a form that can be reproduced by the speaker and outputs the result. Note that the compression encoded signal of still image recorded in the external memory 10 is also processed in the same manner. Specifically, the expansion processing portion 12 expands and decodes the compression encoded signal to generate an image signal, and the image signal output circuit portion 13 converts the image signal into a form that can be reproduced by the display device and outputs the result.

Note that the display device and the speaker may be integrated to the image pickup device 1 or may be separated from the image pickup device 1 to be connected to the same via a terminal provided to the same and a cable or the like.

In addition, in a so-called preview mode for a user to check the image displayed on the display device or the like without recording the image signal, the image signal output from the image processing portion 5 may be delivered to the image signal output circuit portion 13 without being compressed. In addition, when the image signal is recorded, in parallel to the action of compressing by the compression processing portion 9 and recording in the external memory 10, the image signal may be delivered to the display device or the like via the image signal output circuit portion 13.

<<Distortion Compensation>>

Next, distortion compensation that can be performed by the image pickup device 1 of this embodiment is described with reference to the drawings. Note that the distortion compensation that can be performed by the image pickup device 1 of this embodiment is mainly performed by the image sensor 2 and the image processing portion 5. Therefore, in the following description of the distortion compensation in each example, specific examples of structures and actions of the image sensor 2 and the image processing portion 5 are described particularly in detail. In addition, in the following description, an image signal is also expressed as an image for specific description.

### First Example

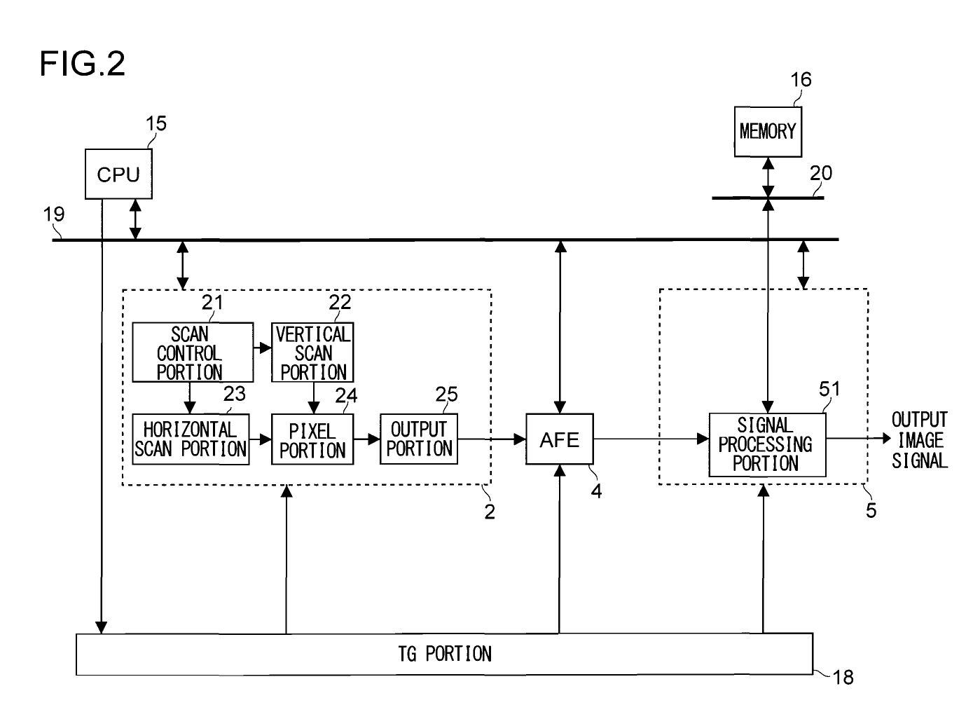

FIG. 2 is a block diagram illustrating a structure of a main part of the image pickup device that can perform the distortion compensation of a first example. As illustrated in FIG. 2, the image sensor 2 includes a pixel portion 24 in which a plurality of pixels are arranged, a vertical scan portion 22 that designates a position in a vertical direction of the pixel to be exposed and read in the pixel portion 24, a horizontal scan portion 23 that designates a position in a horizontal direction (perpendicular to the vertical direction) of the pixel to be exposed and read in the pixel portion 24, a scan control portion 21 that controls the vertical scan portion 22 and the horizontal scan portion 23, and an output portion 25 that outputs pixel signals read out sequentially from the pixel portion 24 as the image signal from the image sensor 2. In addition, the image processing portion 5 includes a signal processing portion 51 that processes the input image to generate and output an output image.

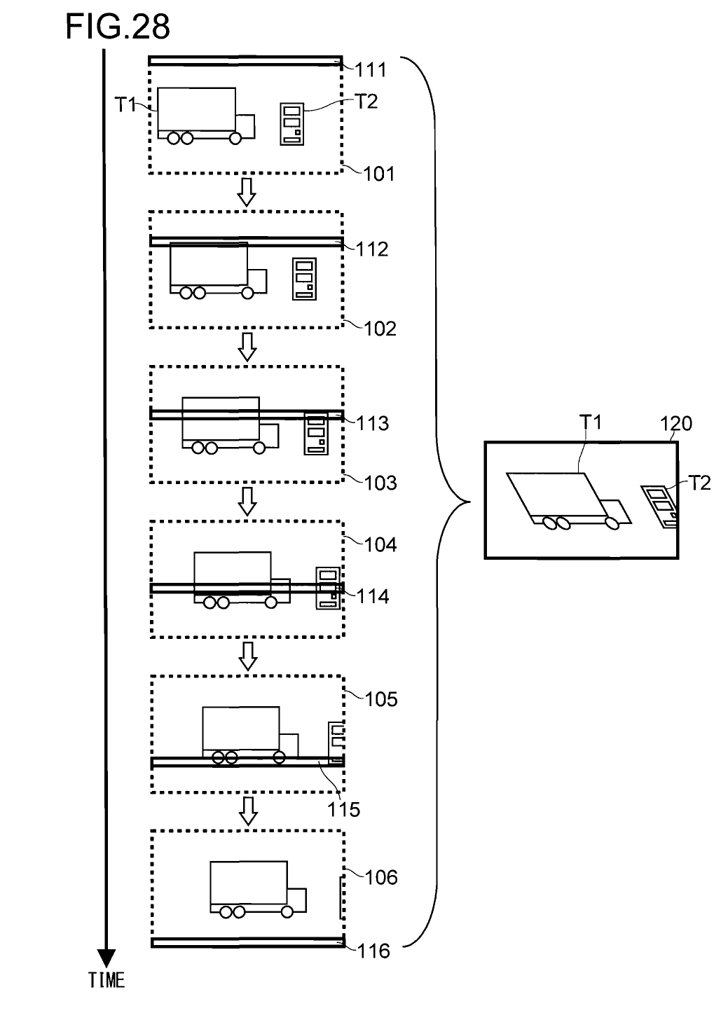

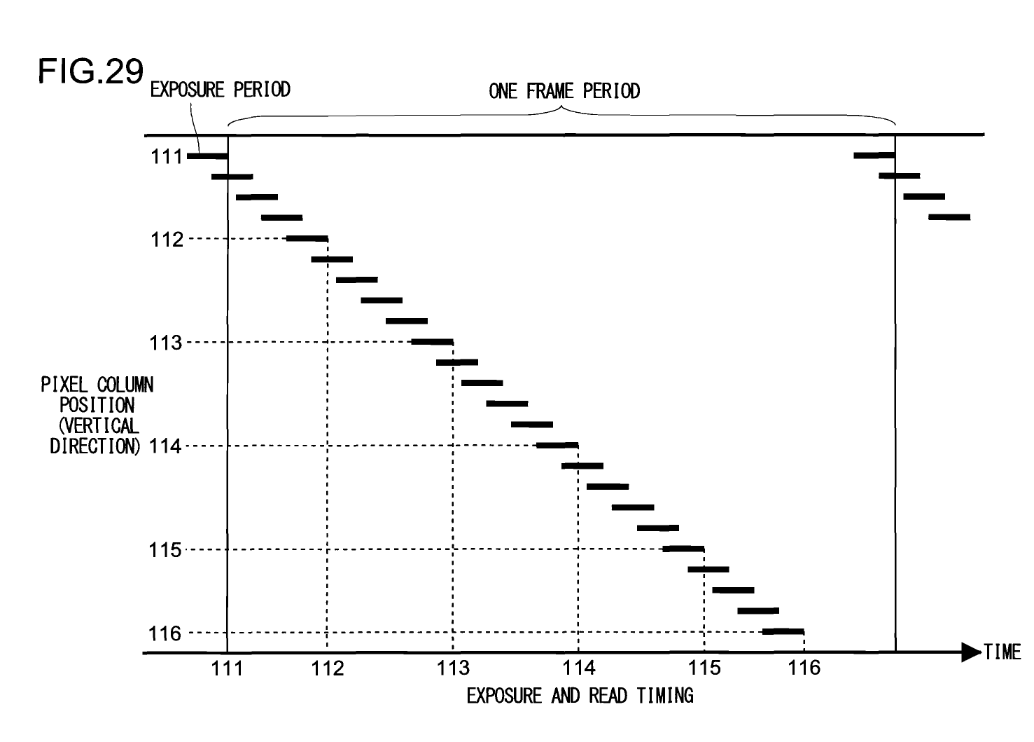

The vertical scan portion 22 and the horizontal scan portion 23 can perform exposure and reading by designating arbitrary pixels in the pixel portion 24, and the scan control portion 21 controls order of pixels to be exposed and read as well as timing thereof (hereinafter referred to as an exposure and reading pattern). The scan control portion 21 can perform control of exposure and reading by switching between an ordinary exposure and reading pattern illustrated in FIGS. 28 and 29 and a special exposure and reading pattern to be used for reducing distortion (hereinafter referred to as exposure and reading pattern for reducing distortion). The switching of the exposure and reading pattern is performed by the CPU 15, for example. Note that details of the exposure and reading pattern for reducing distortion will be described later.

The pixel signals read out from the pixel portion 24 are supplied to the output portion 25 and are output from the output portion 25 as an image having the pixel signals (pixel values). The image output from the output portion 25 is supplied to the AFE 4 as described above and is converted into a digital signal, which is supplied to the image processing portion 5. The image processing portion 5 makes the memory 16 to temporarily store the supplied image and reads out the same by the signal processing portion 51 as necessary and performs above-mentioned various processing on the same so as to generate the output image and output the same. In this case, if the image supplied to the image processing portion 5 is the image obtained by exposure and reading using the exposure and reading pattern for reducing distortion, the signal processing portion 51 performs the corresponding process.

In this way, in the distortion compensation of this example, the image sensor 2 performs exposure and reading using the exposure and reading pattern for reducing distortion so that a predetermined image is generated, and the signal processing portion 51 performs a predetermined process on the predetermined image so that an output image with reduced distortion is generated.

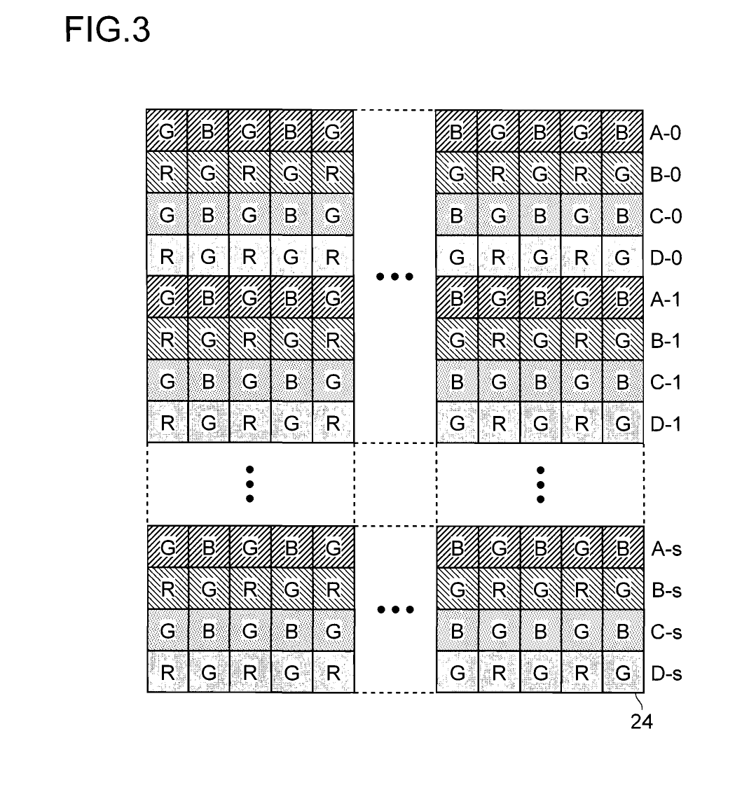

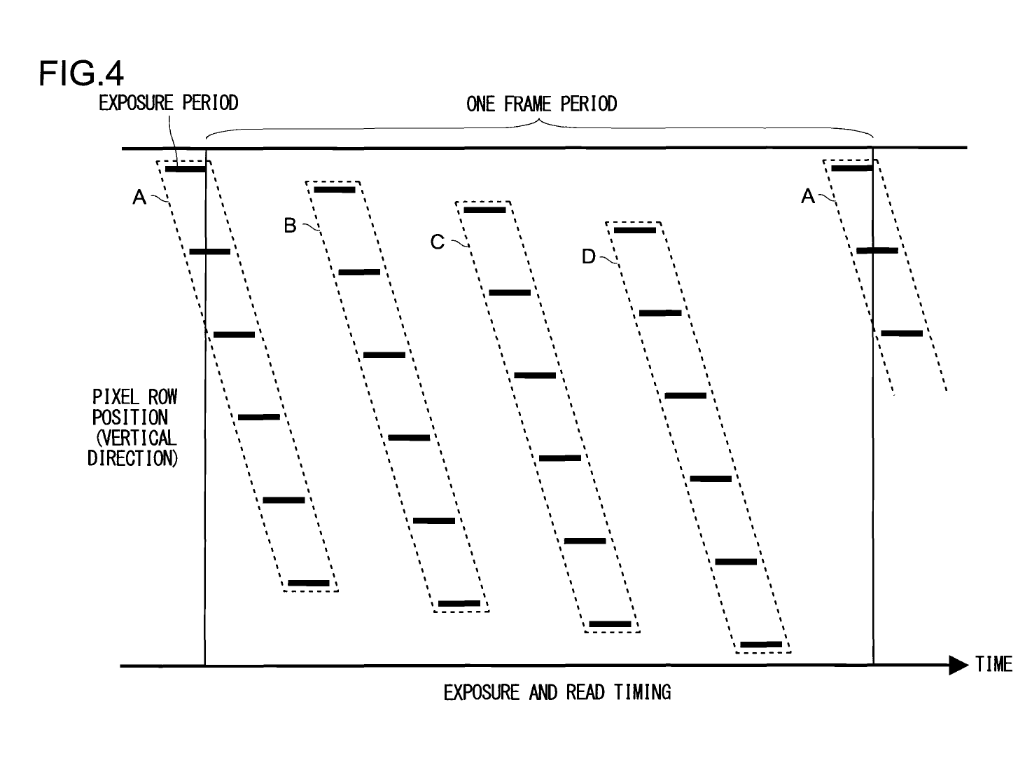

Next, one example of the exposure and reading pattern for reducing distortion is described with reference to the drawings. FIG. 3 is a diagram of the pixel portion illustrating a pixel arrangement and one example of the exposure and reading pattern for reducing distortion. In addition, FIG. 4 is a timing chart illustrating exposure timing and read timing when exposure and reading are performed using the exposure and reading pattern for reducing distortion illustrated in FIG. 3, which corresponds to FIG. 29 illustrating the ordinary exposure and reading pattern.

The pixel portion 24 illustrated in FIG. 3 has an arrangement (so-called Bayer arrangement), in which pixel rows having G and B pixels arranged alternately in the horizontal direction (left and right direction in the diagram) and pixel rows having G and R pixels arranged alternately in the horizontal direction are arranged alternately in the vertical direction (up and down direction in the diagram), and pixel columns having G and R pixels arranged alternately in the vertical direction and pixel columns having G and B pixels arranged alternately in the vertical direction are arranged alternately in the horizontal direction. For instance, when a position of each pixel (in the horizontal direction and in the vertical direction) is expressed by (X, Y) in which the value of X increases toward right while the value of Y increases toward down, it is possible that G pixels are located at (2n, 2m) and (2n+1, 2m+1), an R pixel is located at (2n, 2m+1), and a B pixel is located at (2n+1, 2m) (n and m denote integers). Note that for specific description in the following description, it is supposed that the upper left pixel is a G pixel whose position is (0, 0) and that n and m are integers of zero or larger.

As illustrated in FIGS. 28 and 29, in the ordinary exposure and reading pattern, exposure and reading are performed on the pixel rows of the pixel portion 24 arranged in the vertical direction in one direction (from up to down) continuously (in order with respect to adjacent pixel rows). In contrast, although the exposure and reading pattern for reducing distortion of this example is similar to the ordinary exposure and reading pattern in that exposure and reading are performed on the pixel rows of the pixel portion 24 arranged in the vertical direction in one direction (from up to down), the former is different from the latter in that exposure and reading are performed discontinuously. Hereinafter, a specific example of the exposure and reading pattern for reducing distortion of this example is described.

The exposure and reading pattern for reducing distortion of this example classifies pixels of the pixel portion 24 illustrated in FIG. 3 into predetermined “pixel groups”, so that exposure and reading are performed in order by the pixel group. Note that the example of the exposure and reading pattern for reducing distortion illustrated in FIGS. 3 and 4 classifies pixel rows into four pixel groups A to D based on the position in the vertical direction. Specifically, the pixel rows are classified into pixel groups A to D every four rows in the vertical direction.

More specifically, the pixels are classified so that pixels (x, 4v) are included in the pixel group A, pixels (x, 4v+1) are included in the pixel group B, pixels (x, 4v+2) are included in the pixel group C, and pixels (x, 4v+3) are included in the pixel group D (here, x and v denote integers of zero or larger). Note that the number of pixel rows of the pixel portion 24 is an integral multiple of four so that the number of pixels included in each group is the same among the pixel groups A to D in FIG. 3 as one example, but this is not a limitation. An arbitrary number may be adopted as the number of pixel rows.

Then, exposure and reading are performed in order of the pixel group A, the pixel group B, the pixel group C, and the pixel group D, so as to obtain images constituted of pixel signals of the pixel groups A to D, respectively (hereinafter referred to as a low resolution image; details will be described later). The exposure and reading of the pixel groups A to D are performed similarly to the ordinary exposure and reading pattern, from the upper pixel row to the lower pixel row. Therefore, as to the pixel portion 24 illustrated in FIG. 3, exposure and reading are performed in order of pixel rows A-0, A-1, . . . , A-s, B-0, B-1, . . . , B-s, C-0, C-1, . . . , C-s, D-0, D-1, . . . , D-s (s is a natural number).

As described above, similarly to the ordinary exposure and reading pattern, exposure and reading of pixels in substantially the entire pixel portion 24 are performed. Therefore, the exposure and reading pattern for reducing distortion of this example can be regarded as the one in which the order of pixels to be exposed and read (pixel rows in particular) is changed from the ordinary exposure and reading pattern.

In addition, although the exposure and reading pattern for reducing distortion of this example and the ordinary exposure and reading pattern have different orders of the pixel rows to be exposed and read from each other as described above, they have substantially the same exposure timing and read timing of each pixel row. Therefore, as illustrated in FIGS. 29 and 4, they have substantially the same frame period.

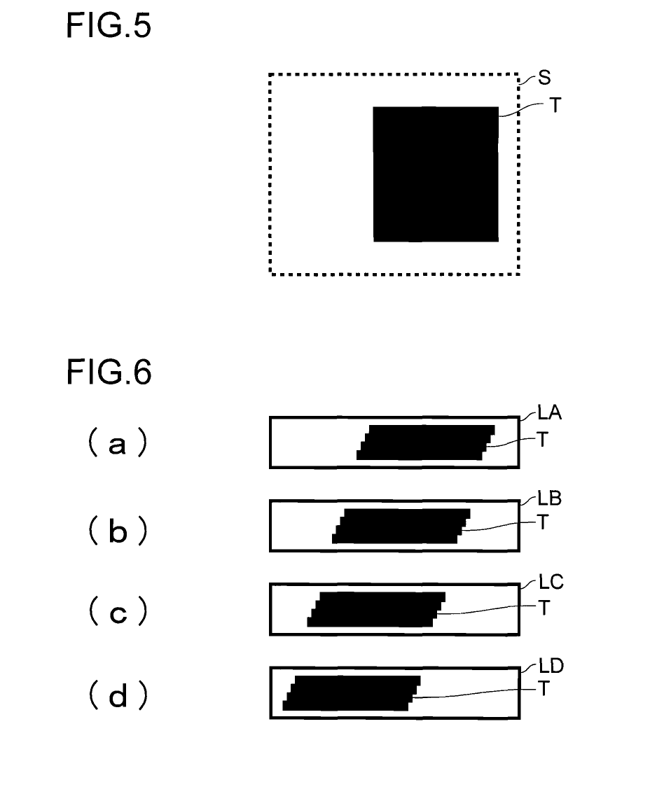

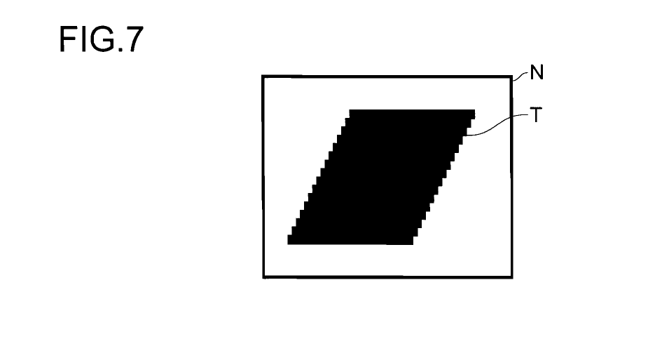

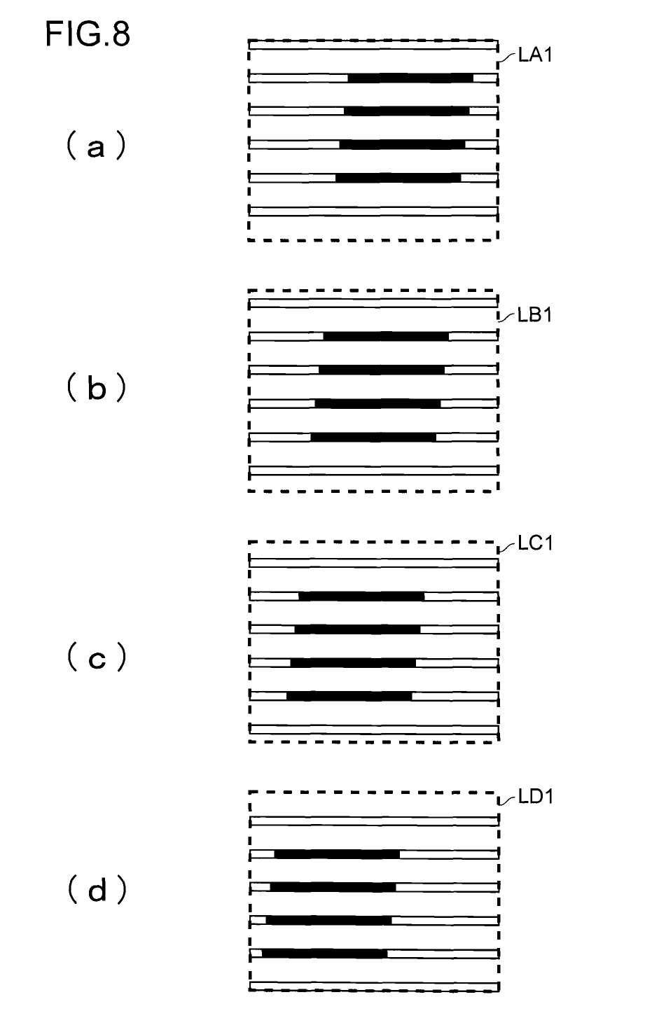

Next, a specific example of low resolution images obtained respectively from the pixel groups A to D is described with reference to the drawings. FIG. 5 is a diagram illustrating one example of an imaging region, and FIGS. 6 and 8 are diagrams illustrating low resolution images obtained by performing exposure and reading using the exposure and reading pattern for reducing distortion. In addition, FIG. 7 is a diagram illustrating an ordinary image obtained by performing exposure and reading using the ordinary exposure and reading pattern, which can be compared with FIGS. 6 and 8. Note that imaging region S illustrated in FIG. 5 is one just before photographing is started. In addition, subject T included in the imaging region S has a rectangular shape having sides parallel to the vertical direction and sides parallel to the horizontal direction.

Low resolution images LA to LD illustrated in FIGS. 6(a) to 6(d) and ordinary image N illustrated in FIG. 7 are obtained by starting photographing in a state of the imaging region S illustrated in FIG. 5 and by panning the image pickup device 1 to the right during photographing. In addition, the low resolution image LA illustrated in FIG. 6(a) is an image obtained by exposure and reading of the pixel group A. Similarly, the low resolution image LB illustrated in FIG. 6(b) is an image obtained by exposure and reading of the pixel group B, the low resolution image LC illustrated in FIG. 6(c) is an image obtained by exposure and reading of the pixel group C, and the low resolution image LD illustrated in FIG. 6(d) is an image obtained by exposure and reading of the pixel group D.

Comparing each of the low resolution images LA to LD illustrated in FIGS. 6(a) to 6(d) with the ordinary image N illustrated in FIG. 7, they have the same resolution (number of pixels) in the horizontal direction. On the other hand, because the low resolution images LA to LD are images obtained by performing exposure and reading of every four pixel rows in the pixel portion 24, the resolution in the vertical direction thereof is substantially one fourth of the resolution of the ordinary image N that is obtained by continuously performing exposure and reading of the pixel rows in the pixel portion 24.

As described above, the ordinary exposure and reading pattern and the exposure and reading pattern for reducing distortion of this example have substantially the same exposure timing and read timing of each pixel row. Therefore, amplitude of distortion generated in each of the low resolution images LA to LD is substantially the same as that generated in the ordinary image N. Specifically, for example, in the low resolution images LA to LD and in the ordinary image N, gradient (namely, distortion) of a side of the subject T that is originally to be parallel to the vertical direction is substantially the same as for the subject T in the images.

Here, the pixel rows of the low resolution images LA to LD are obtained by performing exposure and reading of pixel rows at discontinuous positions (every four rows) in the pixel portion 24, substantial amplitudes of distortion thereof are expressed by low resolution images LA1 to LD1, the pixel rows are placed at the original positions in the pixel portion 24 (see FIG. 3) as illustrated in FIGS. 8(a) to 8(d). Note that the low resolution images LA1 to LD1 illustrated in FIGS. 8(a) to 8(d) correspond to low resolution images LA to LD illustrated in FIGS. 6(a) to 6(d), respectively.

Comparing the low resolution images LA1 to LD1 with the low resolution images LA to LD, respectively, an interval between the pixel rows is four times and the above-mentioned gradient (namely, distortion) of the side of the subject T is one fourth. Therefore, substantial distortion of the low resolution images LA to LD is reduced to one fourth of that of the ordinary image N.

The signal processing portion 51 generates the output image using at least one of the low resolution images LA to LD with reduced distortion generated as described above (for example, by combining the low resolution images LA to LD appropriately). Therefore, it is possible to generate the output image with smaller distortion than the ordinary image N.

Further, it is also possible to suppress deterioration of resolution of the output image due to the use of the low resolution images LA to LD if the output image is generated by using a plurality of low resolution images LA to LD having different positions of pixels in the pixel portion 24 at which the pixel signals are obtained.

In addition, in the distortion compensation of this example, exposure timing and read timing are substantially the same as those of the ordinary exposure and reading pattern. Therefore, the distortion compensation of this example can be performed without a large change in the structure after the AFE 4.

Note that there is described the case where the pixels are classified into the four pixel groups A to D so as to generate the four low resolution images LA to LD in the above example, but the number of pixel groups is not limited to four but may be k (k denotes an integer of two or larger). In this case, the pixel rows may be classified into pixel groups every k pixel rows in the vertical direction of the pixel portion 24. The low resolution image obtained in this way can reduce distortion to 1/k.

In addition, when exposure and reading are performed in a discontinuous manner in the vertical direction of the pixel rows in the pixel portion 24, distortion of the low resolution image can be reduced. Therefore, it is possible to perform exposure and reading in an irregular manner. However, if exposure and reading are performed regularly (for example, every k pixel rows) for discontinuous pixel rows as the above-mentioned example, it is preferred because the reduced distortion becomes uniform in the vertical direction.

In addition, because distortion reducing effect of the low resolution image can be obtained as long as exposure and reading are performed in a discontinuous manner, the effect of distortion compensation can be obtained even by using the low resolution image obtained by performing exposure and reading in a discontinuous manner in the horizontal direction.

### Second Example

Next, a second example of the distortion compensation is described. Similarly to the first example, the second example also generates the image with reduced distortion using a low resolution image. However, the second example illustrates a specific example of a method of generating the output image using a low resolution image, and the generating method of the low resolution image is the same as that in the first example. Therefore, because the generating method of the low resolution image is the same as that in the first example, detailed description thereof is omitted.

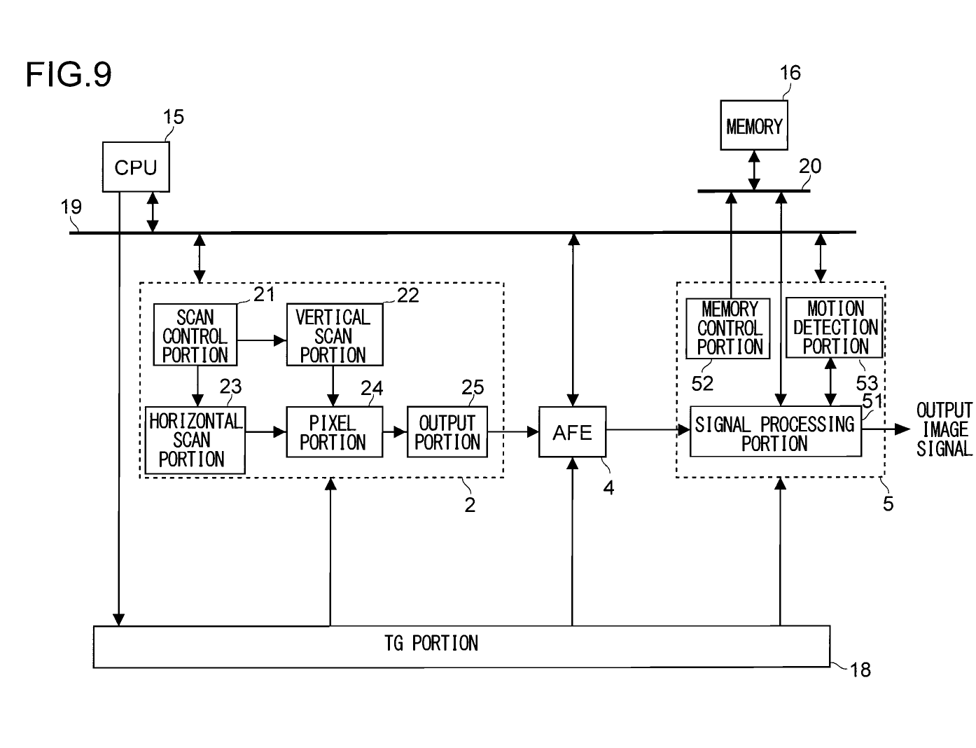

A structure of a main part of the image pickup device that can perform this example is described with reference to the drawings. FIG. 9 is a block diagram illustrating a structure of a main part of the image pickup device that can perform distortion compensation of the second example. Note that a part similar to that of FIG. 2 illustrating the first example is denoted by the same numeral or symbol, and detailed description thereof is omitted.

As illustrated in FIG. 9, the structure of the image sensor 2 is the same as that in the first example. Therefore, when the image sensor 2 performs exposure and reading using the exposure and reading pattern for reducing distortion, the low resolution image is supplied from the AFE 4 to the image processing portion 5 sequentially. Note that in the following description, for specific description, there is described a case where the output image is generated using the low resolution images LA to LD (see FIG. 6) obtained by using the exposure and reading pattern for reducing distortion (see FIGS. 3 and 4) described in the first example.

The image processing portion 5 further includes the signal processing portion 51, a memory control portion 52 that controls signal reading of the low resolution images from the memory 16 to the signal processing portion 51, and a motion detection portion 53 that detects a motion between the low resolution images.

The memory control portion 52 reads out low resolution images LA to LD stored in the memory 16, sequentially for individual pixel rows, so as to generate a combined image in which pixel rows of the multiple low resolution images LA to LD are arranged vertically in a discontinuous manner and are combined. The discontinuous manner of the arrangement of the pixel rows in the combined image is the same as the discontinuous manner when the exposure and reading are performed. In other words, the combined image is generated by combining the pixel rows constituting the low resolution images LA to LD in the arrangement of the original positions in the pixel portion 24 (see FIG. 3).

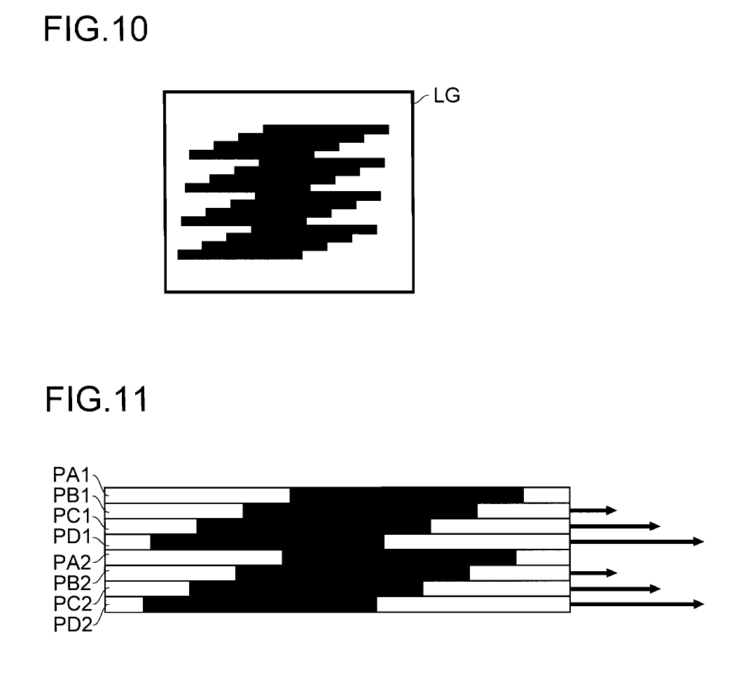

One example of the combined image obtained as described above is illustrated in FIG. 10. The combined image LG illustrated in FIG. 10 is a combination of the pixel rows of the low resolution images LA to LD illustrated in FIG. 6, and is an image in which the low resolution images LA1 to LD1 illustrated in FIG. 8 are overlaid. Because the combined image LG in generated by combining the multiple low resolution images LA to LD by the pixel row, it is possible to substantially improve resolution from the low resolution images LA to LD. However, although distortion is reduced in each of the low resolution images LA to LD, distortions among the low resolution images LA to LD are not reduced. Therefore, distortion between adjacent pixel rows is large in the combined image LG.

Therefore, in this example, the motion detection portion 53 detects a motion between pixel rows obtained from the different low resolution images LA to LD, and based on the detected motion, the signal processing portion 51 performs processing of correcting a position of the pixel row in the horizontal direction (in particular, the pixel row position is corrected in the direction where the detected motion is canceled). Thus, distortion of the combined image LG is reduced.

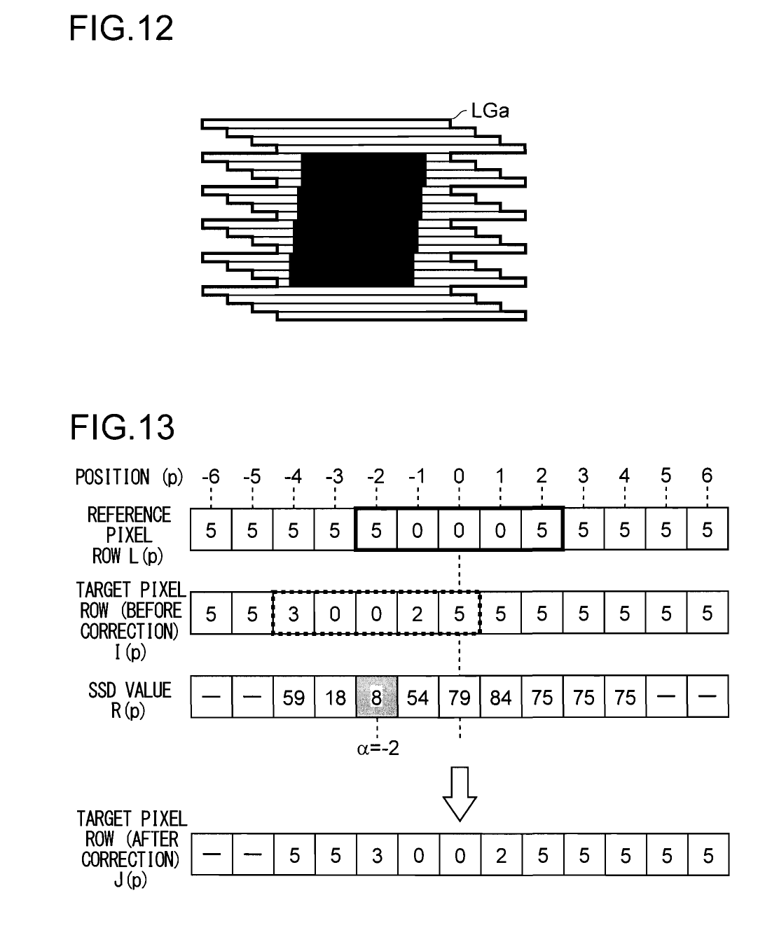

The process of correcting the pixel row position of the combined image is described with reference to the drawings. FIG. 11 is a diagram illustrating one example of processing of correcting the pixel row position of the combined image, and FIG. 12 is a diagram illustrating one example of a corrected combined image obtained by correcting the pixel row position of the combined image illustrated in FIG. 10.

FIG. 11 illustrates eight pixel rows adjacent in the vertical direction in the combined image LG, including PA1, PB1, PC1, PD1, PA2, PB2, PC2, and PD2 in order from the top. PA1 and PA2 are obtained from the low resolution image LA (pixel group A). PB1 and PB2 are obtained from the low resolution image LB (pixel group B). PC1 and PC2 are obtained from the low resolution image LC (pixel group C). PD1 and PD2 are obtained from the low resolution image LD (pixel group D). In this example, the pixel rows PA1 and PA2 obtained from the low resolution image LA (pixel group A) are fixed as individual references (hereinafter referred to as reference pixel rows), and the pixel rows PB1 to PD1 and PB2 to PD2 (hereinafter referred to as target pixel rows) are corrected based on the reference pixel rows obtained from the low resolution images LB to LD (pixel groups B to D).

In this case, when the target pixel rows PB1 to PD1 and PB2 to PD2 are corrected, for example, the upper adjacent pixel rows to them (PA1 for PB1 to PD1 and PA2 for PB2 to PD2) are set as references. Note that it is possible to set the lower adjacent pixel rows (for example, PA2 for PB1 to PD1) as the references. Alternatively, an average of the upper and lower adjacent reference pixel rows (average of PA1 and PA2 for PB1 to PD1) may be set as the reference. Further, the reference pixel rows are not limited to the pixel rows PA1 and PA2 obtained from the low resolution image LA, but pixel rows (PB1 and PB2, PC1 and PC2, or PD1 and PD2) obtained from other low resolution images LB to LD may be set as the reference pixel rows.

When the above-mentioned correction is performed for every target pixel row, corrected combined image LGa illustrated in FIG. 12 can be obtained. Here, when the above-mentioned correction is performed, there may occur a problem that an end in the horizontal direction of the corrected combined image LGa becomes not uniform. Against this problem, it is possible for example to photograph large low resolution images LA to LD in advance, and to clip a predetermined size of image from the obtained corrected combined image so that an image having a uniform end can be obtained. The signal processing portion 51 performs these processes and outputs the obtained image as the output image.

In addition, as one example of the correction method based on the reference pixel row of the target pixel row, a method using template matching is exemplified and is described as follows. The template matching means a method of detecting a portion of a target image similar to a template that is a part of a reference image.

By comparing pixels in the template with pixels in a region having the same size as the template in the target image (hereinafter referred to as a target region), a portion of the target image similar to the template (having high correlation) is detected. In this comparison, it is possible to use R_{SSD} (the following equation (1a)) that is a sum of squared differences (SSD) of pixel values (for example, luminance value) or R_{SAD} (the following equation (1b)) that is a sum of absolute differences (SAD) of pixel values. Note that the center position of the template in the reference image is set as (0, 0) in the following equations (1a) and (1b). In addition, values of SSD and SAD at the position (p, q) are expressed by R_{SSD}(p, q) and R_{SAD}(p, q), a pixel value in the template of the reference image is expressed by L(i, j), a pixel value in the target region centered at the position (p, q) is expressed by I(p+i, q+j), a size (the number of pixels) in the horizontal direction of the template is expressed by 2M+1, and a size (the number of pixels) in the vertical direction of the same is expressed by 2N+1.

$$\begin{matrix}[ Expression 1 ] & \\ {R}_{SSD} ( p , q ) = {\sum }_{j = - N}^{N} {\sum }_{i = - M}^{M} {\{ I ( p + i , q + j ) - L ( i , j ) \}}^{2} & ( 1 a ) \\ {R}_{SAD} ( p , q ) = {\sum }_{j = - N}^{N} {\sum }_{i = - M}^{M} \vert I ( p + i , q + j ) - L ( i , j ) \vert & ( 1 b )\end{matrix}$$

Based on the equations (1a) and (1b), a position (pₘ, qₘ) of the pixel in the target image at which R_{SSD} (p, q) or R_{SAD}(p, q) becomes minimum. The pixel at this position (pₘ, qₘ) has the largest correlation with the pixel at the center (0, 0) of the template to be a corresponding pixel. Therefore, the motion vector (amplitude and direction of motion) between the reference image and the target image can be calculated from a distance and relative positional relationship between the position (0, 0) and the position (pₘ, qₘ).

In the example illustrated the FIG. 11, it is necessary to calculate amplitude and direction of the motion between the reference pixel rows PA1 and PA2 and the target pixel rows PB1 to PD1 and PB2 to PD2 in the horizontal direction, and the motion can be calculated by using the equations (1a) and (1b). Note that in this example, the motion can be detected only by comparing the reference pixel row with the target pixel row and by calculating the motion in the horizontal direction (one-dimensional motion). Therefore, it is possible to use the equations (1a) and (1b) after simplification.

Hereinafter, the calculation method and the correction method of the motion is described with reference to a specific example and the drawings. Note that the case where the one-dimensional template matching is performed using the SSD will be described specifically.

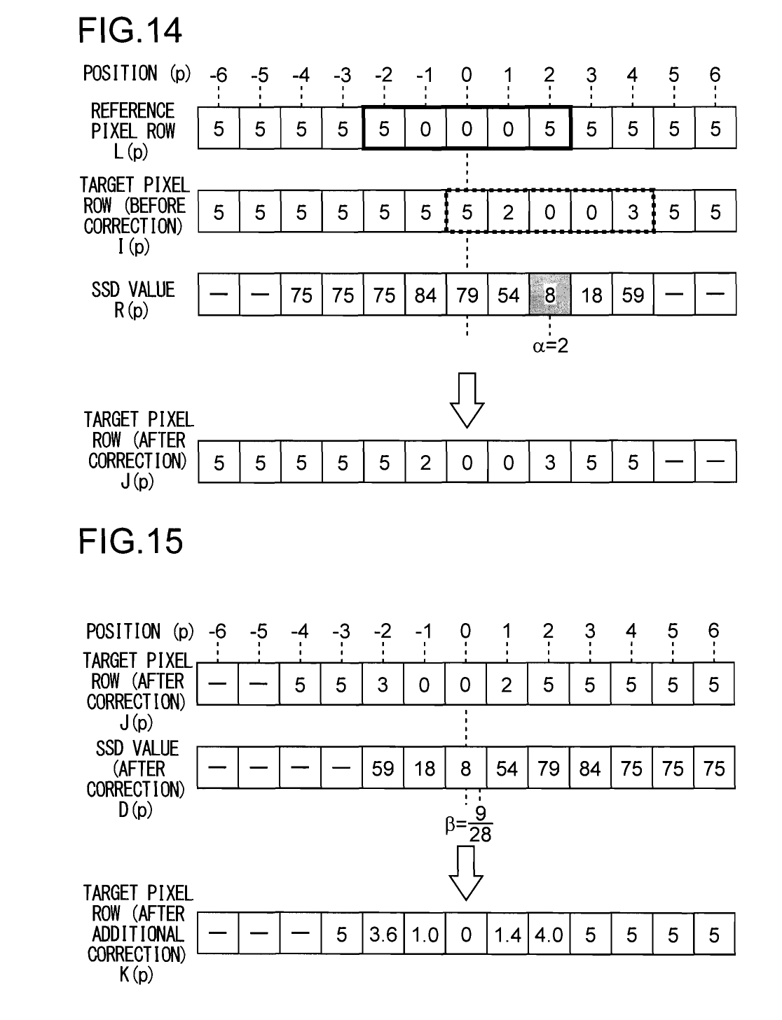

FIGS. 13 and 14 are diagrams illustrating the specific example of the correction method using the template matching. In this example, it is supposed that the size (the number of pixels) in the horizontal direction of the template set in the reference pixel row and a comparison region in the target pixel row is 5, and that the size (the number of pixels) in the vertical direction of the same is 1. Here, only the position in the horizontal direction is considered as described above, and an arbitrary position in the horizontal direction is denoted by p. A pixel value of the reference pixel row at the position p is expressed by L(p), a pixel value of the target pixel row at the position p is expressed by I(p), an SSD value of the position p is expressed by R(p), and a pixel value of the corrected target pixel row at the position p is expressed by J(p). In addition, it is supposed that the center position of the template in the reference pixel row is 0, a position in the right direction is positive, and a position in the left direction is negative.

The SSD value R(p) at the position p is calculated as expressed in the following equation (2). Specifically, for example, when R(−2) illustrated in FIG. 13 is calculated, pixel values L(−2) to L(2) in the template and pixel values I(−4) to I(0) in the comparison region are compared and added for corresponding pixels, respectively. Similarly, when R(2) illustrated in FIG. 14 is calculated, pixel values L(−2) to L(2) in the template and pixel values I(0) to I(4) in the comparison region are compared and added for corresponding pixels, respectively.

$$\begin{matrix}[ Expression 2 ] & \\ R ( p ) = {\sum }_{e = - 2}^{2} {\{ I ( p + e ) - L ( e ) \}}^{2} & ( 2 )\end{matrix}$$

In the example illustrated in FIG. 13, the SSD value R(−2) is the minimum value, while in the example illustrated in FIG. 14, R(2) is the minimum value. In other words, in FIG. 13, the pixel at the target pixel row position (−2) is the pixel corresponding to the center of the template, while in FIG. 13, the pixel at the target pixel row position (2) is the pixel corresponding to the center of the template. As described above, the position pₘ at which the SSD value R(p) is the minimum value indicates the motion between the reference pixel row and the target pixel row.

In this example, this value pₙ, is referred to as a motion value α. An absolute value of the motion value α indicates amplitude of the motion between the reference pixel row and the target pixel row, while a positive or negative sign of the same indicates a direction of the motion. Therefore, in order to correct distortion as described above, correction of moving the target pixel row should be performed so as to cancel the motion value α. Therefore, correction of moving the pixel value of the target pixel row in the horizontal direction is performed by the motion value α as expressed in the following equation (3), so that the pixel value J(p) of the corrected target pixel row is obtained.

[Expression 3]

J(p)=I(p−α) (3)

By performing the correction as described above, it is possible to generate the corrected combined image LGa (see FIG. 12) in which distortions among pixel rows in the combined image LG (see FIG. 10) are decreased. Therefore, it is possible to generate the corrected combined image LGa in which distortion among low resolutions LA to LD is suppressed.

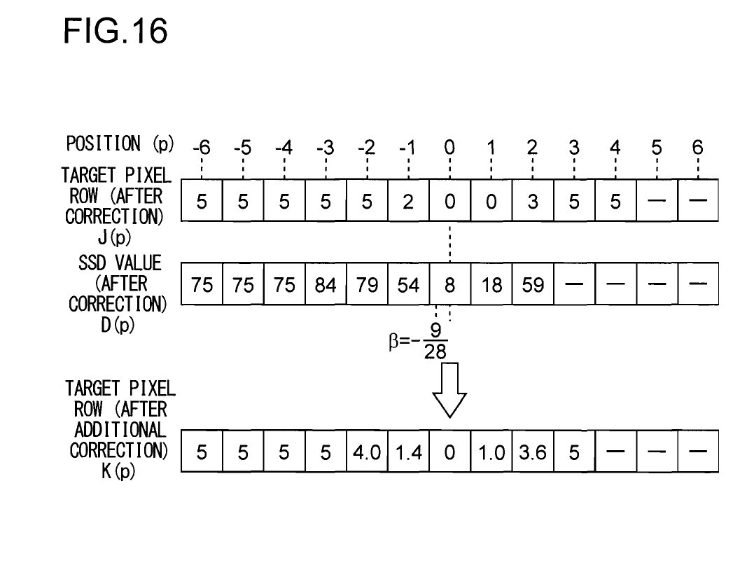

In addition, the correction is performed by the pixel unit in the example illustrated in FIGS. 13 and 14. However, using the value of SSD or SAD, more detailed correction in one pixel (sub pixel) can be performed (hereinafter referred to as additional correction). A specific example of performing the additional correction is illustrated in FIGS. 15 and 16. FIG. 15 illustrates a correction method of performing the additional correction by the sub pixel unit on the corrected target pixel row obtained in FIG. 13. FIG. 16 illustrates a correction method of performing the additional correction by the sub pixel unit on the corrected target pixel row obtained in FIG. 14.

When performing the additional correction illustrated in FIGS. 15 and 16, the SSD value R(p) is also associated with the pixel value J(p) in the corrected target pixel row as an SSD value D(p) after correction using the motion value α (see the following equation (4)). Note that the correction method of the following equation (4) is the same as the above-mentioned correction method of the equation (3).

[Expression 4]

D(p)=R(p−α) (4)

As illustrated in FIGS. 15 and 16, the pixel at the target pixel row position pₘ corresponding to the center of the template is moved to the position 0 by the correction of the equation (3). However, this movement is a movement by the pixel unit, and in view of movement by the sub pixel unit, the position pₙ of the pixel in the target pixel row corresponding to the center of the template may be deviated from the position 0. This deviation can be calculated by further comparison of the SSD value D(p) as expressed in the following equation (5). Here, it is known that −1<pₙ<1 is satisfied because the movement by the pixel unit has performed. Therefore, the calculation is performed using the SSD values D(−1), D(0), and D(1). Note that sub motion value β in the following equation (5) is equal to pₙ and indicates a motion by the sub pixel unit between the reference pixel row and the target pixel row. In other words, the sub motion value β is a value having the same quality as the motion value α.

$$\begin{matrix}[ Expression 5 ] & \\ β = \frac{D ( 1 ) - D ( - 1 )}{2 D ( 1 ) - 4 D ( 0 ) + 2 D ( - 1 )} & ( 5 )\end{matrix}$$

If the target pixel row can be moved so as to cancel the sub motion value β calculated by the equation (5), similarly to the motion value α, the additional correction by the sub pixel unit can be performed. However, the correction by moving the pixel as expressed in the equation (3) can be performed only by the pixel unit, but cannot be applied to this case. Therefore, pixel value K(p) of the target pixel row after the additional correction is calculated by linear interpolation as expressed by the following equations (6a) to (6c).

[Expression 6]

K(p)=J(p)−β{J(p)−J(p−1)}:β>0 (6a)

K(p)=J(p):β=0 (6b)

K(p)=J(p)−β{J(p+1)−J(p)}:β>0 (6c)

If the sub motion value β is positive as illustrated in FIG. 15, the target pixel row is shifted to the positive direction (right direction) as a whole. Therefore, when the pixel value K(p) of the target pixel row after the additional correction is calculated as expressed in the equation (6a), pixel values J(p) and J(p−1) in the corrected target pixel row are used. Similarly, if the sub motion value β is negative as illustrated in FIG. 16, the target pixel row is shifted to the negative direction (left direction) as a whole. Therefore, when the pixel value K(p) of the target pixel row after the additional correction is calculated as expressed in the equation (6c), pixel values J(p) and J(p+1) in the corrected target pixel row are used. Note that if the motion value β is zero, the pixel values before and after the additional correction are the same as expressed in the equation (6b).

By performing the additional correction as described above, distortion between pixel rows in the corrected combined image LGa can be further reduced.

Note that it is preferred to calculate the above-mentioned value of SSD or SAD using the same type of pixel value, and therefore it is possible to calculate in advance the pixel value of the type of the pixel for which the value of SSD or SAD is to be calculated. For instance, it is possible to calculate a luminance value of the pixel to be calculated by using RGB pixel values of pixels around the pixel to be calculated (by calculating RGB values of the pixel to be calculated by interpolation). In addition, for example, by using (by interpolation) G pixel values of the surrounding pixels, the G pixel value of the pixel to be calculated may be calculated.

In addition, it is possible to determine motions among the low resolution images LA to LD by detecting motions during the exposure period by using a sensor (for example, a gyro sensor or the like) that is mounted on the image pickup device or the like for detecting a motion. However, from a viewpoint of downsizing and simplification of the image pickup device 1, it is preferred to calculate using images as described above.

In addition, before reading the pixel rows of the low resolution images LA to LD from the memory 16 to the signal processing portion 51 for generating the corrected combined image LGa, the motion detection portion 53 may calculate motions among the low resolution images LA to LD in advance and may send the result to the memory control portion 52. With this structure, when reading the pixel row from the memory 16, the above-mentioned correction by the pixel unit (see FIG. 12) can be performed by adjusting the read position by the pixel unit.

In addition, even if the exposure and reading pattern for reducing distortion is for performing exposure and reading discontinuously in the horizontal direction, the generating method of the output image of this example can be applied. In this case, it is possible to perform the above-mentioned comparison after calculating the pixel value of an empty pixel in the horizontal direction in the low resolution images to be used for the combination, by interpolation or the like, and to calculate the position and the pixel value of the pixel for which the motion value α, β is to be calculated and combined.

<Other Examples of Exposure and Reading Pattern for Reducing Distortion>

In the above-mentioned first and second examples, the exposure and reading of the pixel are performed to be discontinuous in the vertical direction as illustrated in FIGS. 3 and 4, but the usable exposure and reading pattern for reducing distortion is not limited to this example. Hereinafter, other examples of the exposure and reading pattern for reducing distortion are described with reference to the drawings.

### First Other Example

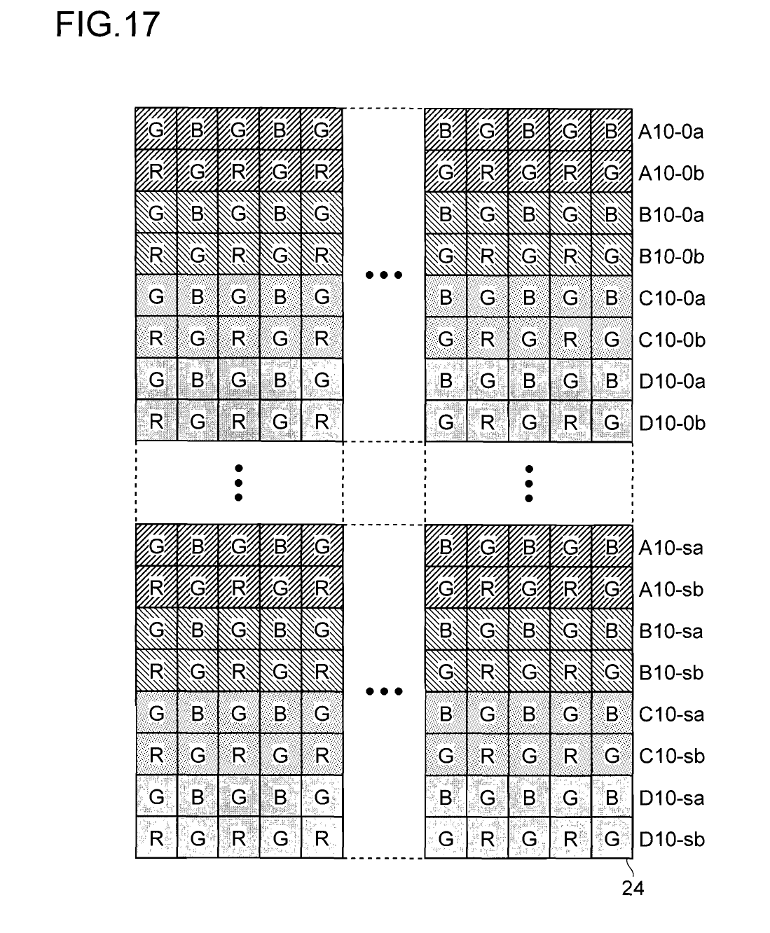

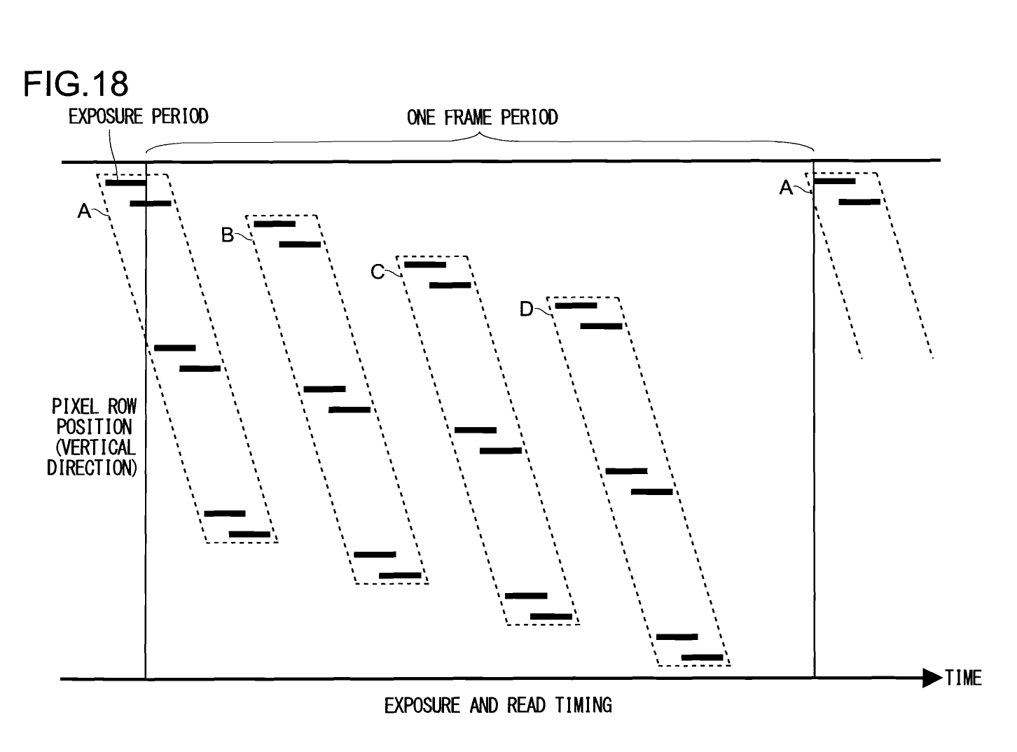

A first other example of the exposure and reading pattern for reducing distortion is described with reference to the drawings. FIG. 17 is a diagram of the pixel portion illustrating the pixel arrangement and the first other example of the exposure and reading pattern for reducing distortion, which corresponds to FIG. 3 illustrating the first example. In addition, FIG. 18 is a timing chart illustrating exposure timing and read timing when the exposure and reading are performed by using the exposure and reading pattern for reducing distortion illustrated in FIG. 17, which corresponds to FIG. 4 illustrating the first example.

In this other example, too, it is supposed that the pixel portion 24 has the Bayer arrangement similarly to FIG. 3. Further, the exposure and reading pattern for reducing distortion of this example is also for classifying pixels into four pixel groups A10 to D10 and for performing the exposure and reading discontinuously in the same manner as the first example, but the classification method of the pixel groups A10 to D10 is different from the first example.

Specifically, the classification is performed so that pixels (x, 8v) and (x, 8v+1) are included in the pixel group A10, pixels (x, 8v+2) and (x, 8v+3) are included in the pixel group B10, pixels (x, 8v+4) and (x, 8v+5) are included in the pixel group C10, pixels (x, 8v+6) and (x, 8v+7) are included in the pixel group D10 (here, x and v denote integers of zero or larger). Note that the number of pixel rows in the pixel portion 24 is an integral multiple of eight in FIG. 17 so that the number of pixels is the same among the pixel groups as one example, but the number of pixel rows may be an arbitrary value without limiting to this.

Then, exposure and reading are performed in order of the pixel group A 10, the pixel group B10, the pixel group C10, and the pixel group D10, so as to obtain the low resolution image constituted of pixel signals of the pixel groups A10 to D10. The exposure and reading of the individual pixel groups A10 to D10 are performed from the upper pixel row to the lower pixel row similarly to the case of the ordinary exposure and reading pattern. Therefore, in the case of the pixel portion 24 of FIG. 17, the exposure and reading are performed in the pixel row order of A10-0a, A10-0b, . . . , A10-sa, A10-sb, B10-0a, B10-0b, . . . , B10-sa, B10-sb, C10-0a, C10-0b, . . . , C10-sa, C10-sb, D10-0a, D10-0b, . . . , D10-sa, and D10-sb (s denotes a natural number).

In this way, the exposure and reading of pixels of substantially the entire pixel portion 24 are performed similarly to the case of the ordinary exposure and reading pattern or the exposure and reading pattern for reducing distortion described above in the first example. Therefore, the exposure and reading pattern for reducing distortion of this other example can also be interpreted to be the one in which the order of pixels (particularly, pixel rows) to be exposed and read of the ordinary exposure and reading pattern are exchanged, similarly to the exposure and reading pattern for reducing distortion described above in the first example.

In addition, although the exposure and reading pattern for reducing distortion of this other example has different order of pixel rows to be exposed and read from that of the ordinary exposure and reading pattern or the exposure and reading pattern for reducing distortion described in the first example as described above, they have substantially the same exposure timing and read timing for each pixel row. Therefore, as illustrated in FIGS. 29, 4, and 18, one frame period of them are substantially the same.

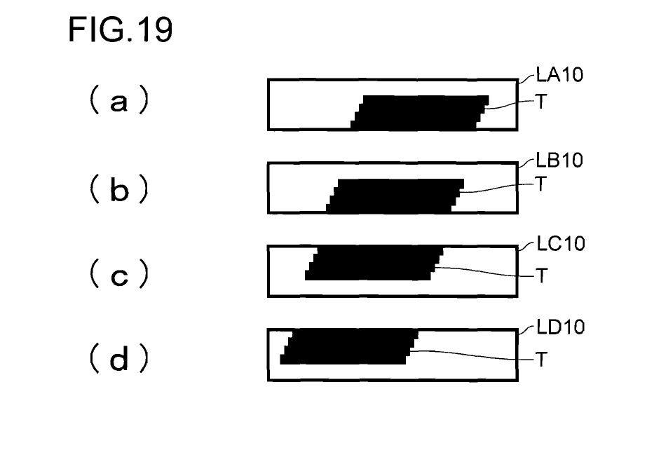

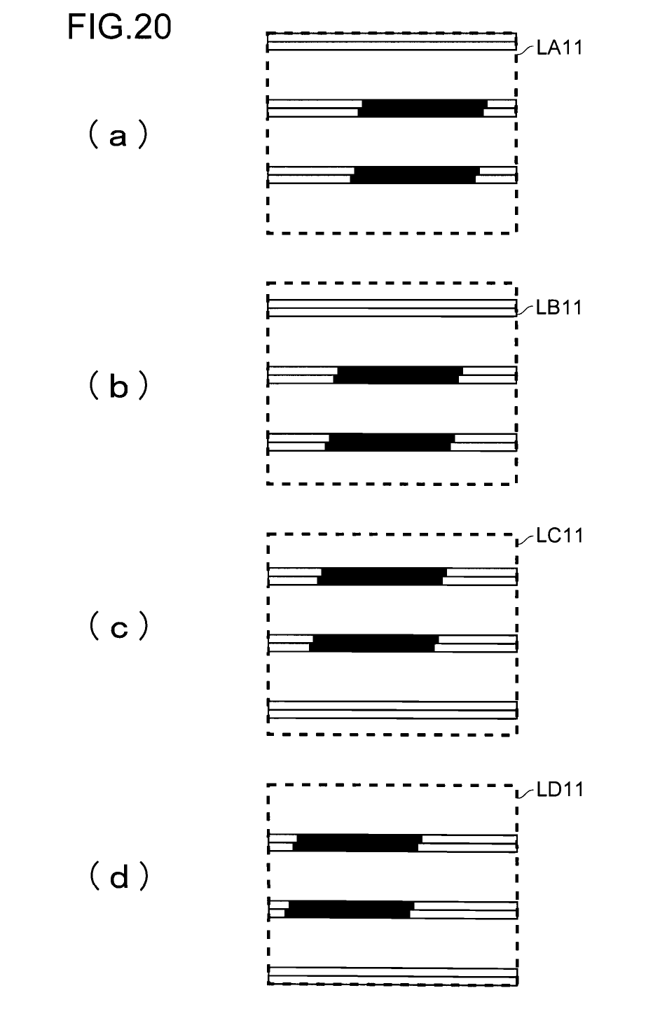

Next, the specific examples of the low resolution images obtained from the pixel groups A10 to D10 are described with reference to the drawings. FIGS. 19 and 20 are diagrams illustrating low resolution images obtained by exposure and reading using the exposure and reading pattern for reducing distortion of the first other example, which can be compared with FIGS. 6 and 8 illustrating the first example. In particular, FIGS. 19 and 20 illustrate low resolution images LA10 to LD10 and LA11 to LD11 obtained by starting photographing in a state of the imaging region S illustrated in FIG. 5 and by panning the image pickup device 1 to the right during photographing, similarly to FIGS. 6 and 8.

The low resolution image LA10 illustrated in FIG. 19(a) is an image obtained by exposure and reading of the pixel group A10. Similarly, the low resolution image LB10 illustrated in FIG. 19(b) is an image obtained by exposure and reading of the pixel group B10, the low resolution image LC10 illustrated in FIG. 19(c) is an image obtained by exposure and reading of the pixel group C10, and the low resolution image LD10 illustrated in FIG. 19(d) is an image obtained by exposure and reading of the pixel group D10.

In addition, the low resolution images LA11 to LD11 illustrated in FIGS. 20(a) to 20(d) are images in which pixel rows of the low resolution images LA10 to LD10 illustrated in FIGS. 19(a) to 19(d) are placed at original positions in the pixel portion 24 (see FIG. 17), which indicates substantial amplitude of distortion similarly to FIGS. 8(a) to 8(d) illustrating the first example. Note that the low resolution images LA11 to LD11 illustrated in FIGS. 20(a) to 20(d) correspond to the low resolution images LA10 to LD10 illustrated in FIGS. 19(a) to 19(d), respectively.

In the low resolution images LA11 to LD11 of the first other example illustrated in FIGS. 20(a) to 20(d), sets of two adjacent pixel rows are arranged at intervals of six rows. Therefore, similarly to the first example, the pixel row interval of the low resolution images LA11 to LD11 is four times that of the low resolution images LA10 to LD10. Therefore, substantial distortion of the low resolution images LA10 to LD10 is reduced to one fourth of that of the ordinary image N.

Therefore, similarly to the first example, by generating the output image using at least one of the low resolution images LA10 to LD10, it is possible to generate the output image in which distortion is reduced more than the ordinary image N. In addition, by generating the output image using a plurality of the low resolution images LA10 to LD10 having different positions in the pixel portion 24 of the obtained pixel signal, it is possible to suppress deterioration of resolution. Further, because the exposure timing and the read timing are substantially the same as those of the ordinary exposure and reading pattern, it is possible to eliminate a large change in a structure of the latter part such as the AFE 4.

Further, in this other example, the exposure and reading are performed successively on the pixel rows of the two adjacent rows. In addition, as illustrated in FIG. 17, in the Bayer arrangement, the adjacent pixel rows include RGB pixels. Therefore, in the low resolution images LA10 to LD10 or in the combined image of them, when a new pixel value such as the luminance value is generated based on the pixel values of the adjacent pixel rows, it is possible to calculate the pixel value accurately.

Here, it is also possible to generate the output image by applying the combining method of the low resolution images described above in the second example to the low resolution images LA10 to LD10 obtained by using the exposure and reading pattern for reducing distortion of this other example. The case where the generating method of the output image described in the second example is used is described with reference to the drawings.

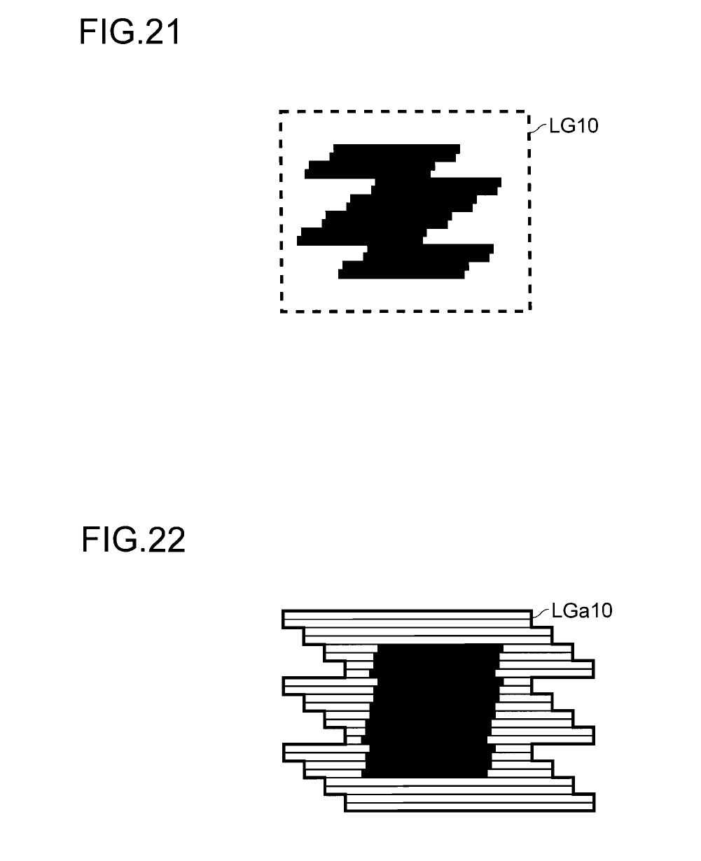

FIG. 21 is a diagram illustrating one example of a combined image obtained by combining low resolution images obtained by using the exposure and reading pattern for reducing distortion of the first other example, which correspond to FIG. 10 illustrating the second example. FIG. 22 is a diagram illustrating one example of the corrected combined image obtained by correcting the pixel row position of the combined image illustrated in FIG. 21, which corresponds to FIG. 12 illustrating the second example.

The combined image LG10 illustrated in FIG. 21 is an image in which pixel rows of the low resolution images LA10 to LD10 illustrated in FIG. 19 are combined, which is an image obtained by overlaying the low resolution images LA11 to LD11 illustrated in FIG. 20. In the combined image LG10, exposure and reading of the two adjacent pixel rows are performed successively as described above. Therefore, as illustrated in the corrected combined image LGa10 of FIG. 22 for example, the correction may be performed for each two adjacent rows. Further in this case, when the motion value α, β is calculated, it is possible to use a two-dimensional template in which the number of rows is two (the equation (1a) or (1b)). Note that it is possible to correct the pixel row for each row as illustrated in the second example.

With this structure, similarly to the second example, it is possible to generate the corrected combined image LGa10 (see FIG. 22) in which distortions among pixel rows in the combined image LG10 (see FIG. 21) are reduced. In addition, it is possible to calculate luminance values or the like of the low resolution images LA10 to LD10 accurately as described above. Therefore, by using these pixel values, the motion value α, β can be calculated accurately.

Note that the case where pixels are divided into four pixel groups A10 to D10 so that the four low resolution images LA10 to LD10 are generated is exemplified, but the number of dividing pixel groups is not limited to four but may be k (k denotes an integer of two or larger). Further, the exposure and reading are performed successively for the pixel rows of two adjacent rows, but the number of the adjacent pixel rows is not limited to two but may be u (u denotes an integer of two or larger). In this case, a set of u rows may be classified into the same pixel group at an interval of u×(k−1) rows in the vertical direction of the pixel portion 24. The low resolution image obtained in this way can reduce the distortion to be 1/k.

### Second Other Example

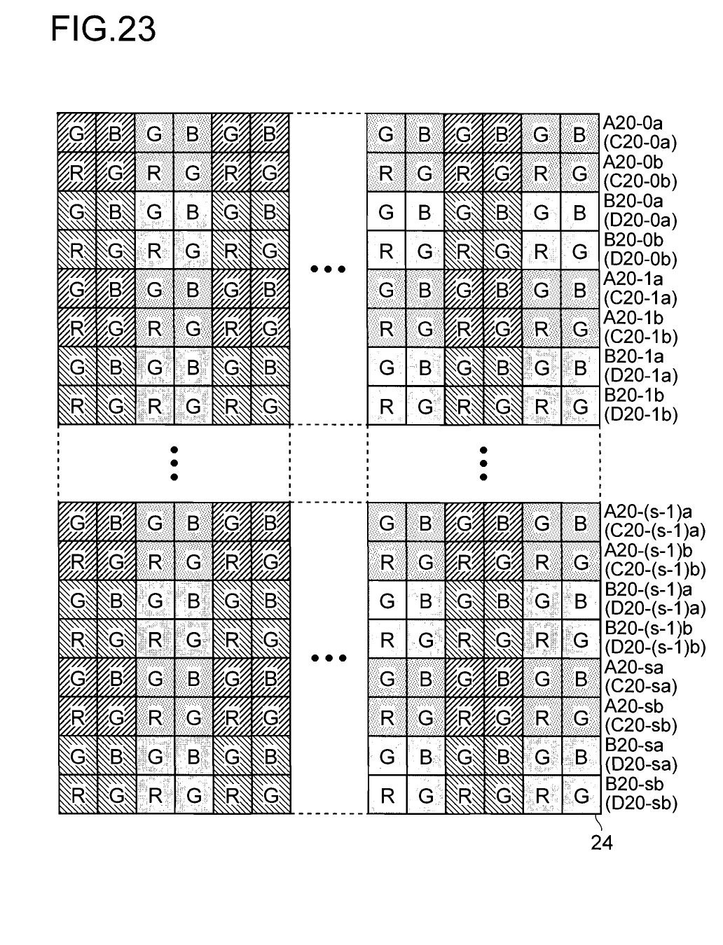

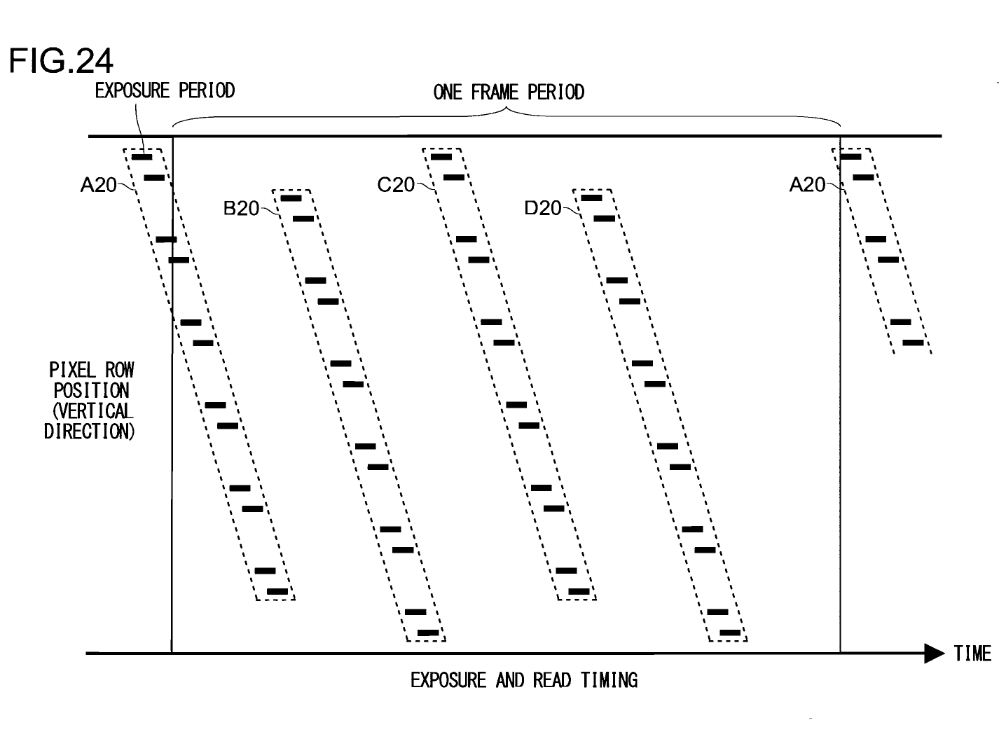

In addition, a second other example of the exposure and reading pattern for reducing distortion is described with reference to the drawings. FIG. 23 is a diagram of the pixel portion illustrating the pixel arrangement and the second other example of the exposure and reading pattern for reducing distortion, which corresponds to FIG. 3 illustrating the first example. In addition, FIG. 24 is a timing chart illustrating exposure timing and read timing when the exposure and reading are performed by using the exposure and reading pattern for reducing distortion illustrated in FIG. 23, which corresponds to FIG. 4 illustrating the first example.

In this other example, too, it is supposed that the pixel portion 24 has the Bayer arrangement similarly to FIG. 3. Further, the exposure and reading pattern for reducing distortion of this example is also for classifying pixels into four pixel groups A20 to D20 and for performing the exposure and reading discontinuously in the same manner as the first example, but the classification method of the pixel groups A20 to D20 is different from the first example.

Specifically, classification is performed so that pixels (4h, 4v), (4h+1, 4v), (4h, 4v+1), and (4h+1, 4v+1) are included in the pixel group A20, pixels (4h, 4v+2), (4h+1, 4v+2), (4h, 4v+3), and (4h+1, 4v+3) are included in the pixel group B20, pixels (4h+2, 4v), (4h+3, 4v), (4h+2, 4v+1), and (4h+3, 4v+1) are included in the pixel group C20, and pixels (4h+2, 4v+2), (4h+3, 4v+2), (4h+2, 4v+3), and (4h+3, 4v+3) are included in the pixel group D20 (here, h and v denote integers of zero or larger). Note that the numbers of pixel rows and pixel columns in the pixel portion 24 are integral multiples of four so that the number of pixels is the same among the pixel groups as one example in FIG. 23, but the numbers of pixel rows and pixel columns may be an arbitrary value without limiting to this.

Then, the exposure and reading are performed in order of the pixel group A20, the pixel group B20, the pixel group C20, and the pixel group D20, so as to obtain the low resolution image constituted of pixel signals of the pixel groups A20 to D20. The exposure and reading of the individual pixel groups A20 to D20 are performed from the upper pixel row to the lower pixel row similarly to the case of the ordinary exposure and reading pattern. Therefore, in the case of the pixel portion 24 of FIG. 23, the exposure and reading are performed in order of the pixel rows A20-0a, A20-0b, . . . , A20-sa, A20-sb, B20-0a, B20-0b, . . . , B20-sa, B20-sb, C20-0a, C20-0b, . . . , C20-sa, C20-sb, D20-0a, D20-0b, . . . , D20-sa, and D10-sb (s denotes a natural number).

In this way, the exposure and reading of pixels of substantially the entire pixel portion 24 are performed similarly to the case of the ordinary exposure and reading pattern or the exposure and reading pattern for reducing distortion described above in the first example. Therefore, the exposure and reading pattern for reducing distortion of this other example is for performing the exposure and reading discontinuously not only in the vertical direction but also in the horizontal direction, and can also be interpreted to be the one in which the order of pixels to be exposed and read of the ordinary exposure and reading pattern are exchanged, similarly to the exposure and reading pattern for reducing distortion described above in the first example.

In addition, exposure and reading time for one pixel row in the exposure and reading pattern for reducing distortion of this other example is substantially a half of that in the ordinary exposure and reading pattern or the exposure and reading pattern for reducing distortion of the first example. However, the pixel rows to be exposed and read are substantially doubled. Therefore, as illustrated in FIGS. 29, 4, and 24, one frame period of them become substantially the same.

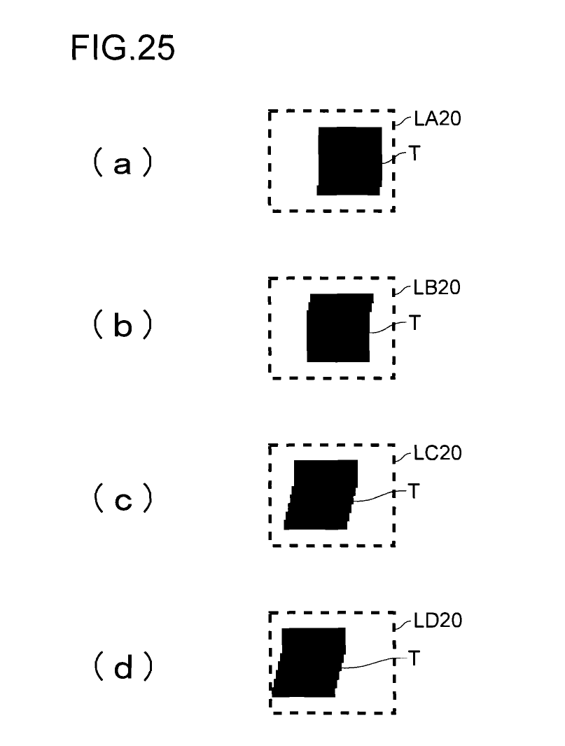

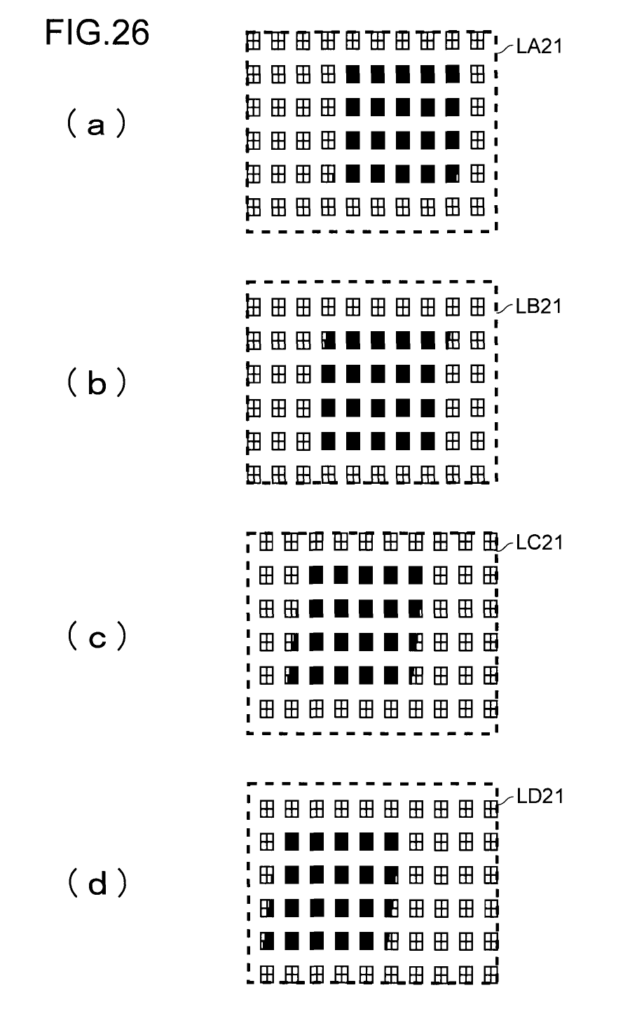

Next, specific examples of the low resolution images obtained respectively from the pixel groups A20 to D20 are described with reference to the drawings. FIGS. 25 and 26 are diagrams illustrating low resolution images obtained by performing the exposure and reading using the exposure and reading pattern for reducing distortion of the second other example, which can be compared with FIGS. 6 and 8 illustrating the first example. In particular, similarly to FIGS. 6 and 8, FIGS. 25 and 26 illustrate low resolution images LA20 to LD20 and LA21 to LD21 obtained by starting photographing in a state of the imaging region S illustrated in FIG. 5 and by panning the image pickup device 1 to the right during photographing.

The low resolution image LA20 illustrated in FIG. 25(a) is an image obtained by the exposure and reading of the pixel group A20. Similarly, the low resolution image LB20 illustrated in FIG. 25(b) is an image obtained by exposure and reading of the pixel group B20, the low resolution image LC20 illustrated in FIG. 25(c) is an image obtained by exposure and reading of the pixel group C20, and the low resolution image LD20 illustrated in FIG. 25(d) is an image obtained by exposure and reading of the pixel group D20.

In addition, the low resolution images LA21 to LD21 illustrated in FIGS. 26(a) to 26(d) are images in which pixel rows of the low resolution images LA20 to LD20 illustrated in FIGS. 25(a) to 25(d) are placed at original positions in the pixel portion 24 (see FIG. 23), which indicates substantial amplitude of distortion similarly to FIGS. 8(a) to 8(d) illustrating the first example. Note that the low resolution images LA21 to LD21 illustrated in FIGS. 26(a) to 26(d) correspond to the low resolution images LA20 to LD20 illustrated in FIGS. 25(a) to 25(d), respectively.

In the low resolution images LA21 to LD21 of the second other example illustrated in FIGS. 26(a) to 26(d), blocks of two rows and two columns are arranged at intervals of two rows in the vertical direction and two columns in the horizontal direction. Therefore, the pixel row interval of the low resolution images LA21 to LD21 is twice that of the low resolution images LA20 to LD20. In addition, because pixels in the horizontal direction is a half of the entire pixel row, the exposure period becomes a half (see FIG. 24), and distortion of each pixel row becomes a half of that of the ordinary image N. Therefore, substantial distortion of the low resolution images LA20 to LD20 is reduced to one fourth of that of the ordinary image N.

Therefore, similarly to the first example, by generating the output image using at least one of the low resolution images LA20 to LD20, it is possible to generate the output image in which distortion is reduced more than the ordinary image N. In addition, by generating the output image using a plurality of the low resolution images LA20 to LD20 having different positions in the pixel portion 24 of the obtained pixel signal, it is possible to suppress deterioration of resolution. Further, because the number of pixels to be exposed and read is substantially the same as that of the ordinary exposure and reading pattern so that the pixel signals can be read out at substantially the same speed, it is possible to eliminate a large change in a structure of the latter part such as the AFE 4.

Further, in this other example, the exposure and reading are performed successively on the adjacent pixels of two rows and two columns. In addition, as illustrated in FIG. 23, in the Bayer arrangement, the adjacent pixel rows include RGB pixels. Therefore, in the low resolution images LA20 to LD20 or in the combined image of them, when a new pixel value such as the luminance value is generated based on the pixel values of the adjacent pixel rows, it is possible to calculate the pixel value accurately.

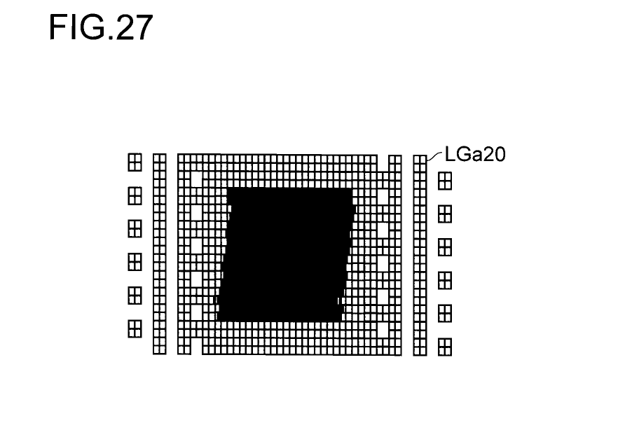

Here, it is also possible to generate the output image by applying the combining method of the low resolution images described above in the second example to the low resolution images LA20 to LD20 obtained by using the exposure and reading pattern for reducing distortion of this other example. The case where the generating method of the output image described in the second example is used is described with reference to the drawings. FIG. 27 is a diagram illustrating one example of a corrected combined image obtained by combining low resolution images obtained by using the exposure and reading pattern for reducing distortion of the second other example, which correspond to FIG. 12 illustrating the second example.

The corrected combined image LGa20 illustrated in FIG. 27 is an image in which pixel positions of the low resolution images LA20 to LD20 illustrated in FIG. 25 are corrected and combined, which is an image in which positions of the low resolution images LA21 to LD21 illustrated in FIG. 26 are corrected and overlaid. In this case, it is possible to perform the above-mentioned comparison after calculating the pixel value of an empty pixel in the horizontal or vertical direction in the low resolution images LA21 to LD21 to be used for the combination, by interpolation or the like, and to calculate the position and the pixel value of the pixel for which the motion value α, β is to be calculated and combined.

With this structure, it is possible to generate the corrected combined image LGa20 in which distortion between pixels is reduced. In addition, it is possible to accurately calculate luminance values or the like of the low resolution images LA20 to LD20 as described above. Therefore, by using these pixel values, it is possible to calculate the motion value α, β accurately.

Note that the case where pixels are divided into four pixel groups A20 to D20 so that the four low resolution images LA20 to LD20 are generated is exemplified, but the number of dividing pixel groups is not limited to four but may be k (k denotes an integer of two or larger). Further, it is possible that one pixel group obtains 1/c pixels in the vertical direction and 1/d pixels in the horizontal direction of the pixel portion 24 (c and d denote natural numbers). In this way, the obtained low resolution image can reduce distortion to 1/(c×d).

<Variations>

It is possible to select and use an appropriate exposure and reading pattern as necessary from a plurality of usable exposure and reading patterns including the above-mentioned various exposure and reading patterns for reducing distortion and the ordinary exposure and reading pattern. For instance, the number of division or a pattern of division of the exposure and reading pattern for reducing distortion to be selected may be different in accordance with amplitude of distortion that can be generated (for example, a zoom magnification of the lens portion 3). In particular, if it is expected that the zoom magnification of the lens portion 3 is large so that a large distortion will be generated, it is possible to select the exposure and reading pattern for reducing distortion having large effect of the distortion compensation (for example, the pattern having a large number of division).

On the other hand, if it is expected that the zoom magnification is small so that only a small distortion will be generated, it is possible to perform the exposure and reading using the ordinary exposure and reading pattern so as to generate the ordinary image N and to generate the output image based on the generated ordinary image N. With this structure, it is possible to suppress a distortion of the output image due to wrong distortion compensation and a deterioration of the resolution.

(Control Based on ON/OFF of Shake Correction)

The image pickup device 1 may have a shake correction function. A shake correction technique is a technique of detecting a shake generated when photographing a still image or a moving image, so as to reduce the shake using the detection result. As a shake detection method, there are known a method using a shake detection sensor such as an angular velocity sensor or an angular acceleration sensor, and a method of detecting a shake by image processing of the taken image. As a shake correction method, there are known an optical shake correction method in which a lens or an image pickup element is driven and controlled so as to correct a shake on an optical system side, and an electronic shake correction method in which a blur caused by the shake is removed by image processing. The image pickup device 1 can realize the shake correction function by using the known shake correction technique. In the image pickup device 1, if the shake correction function is turned off (disabled), or if the shake correction function is turned off and it is expected that a focal plane distortion is not relatively conspicuous, it is possible to perform the exposure and reading using the ordinary exposure and reading pattern so as to output an ordinary image, and to generate the output image based on the ordinary image. On the other hand, if the shake correction function is turned on (enabled), it is possible to perform the exposure and reading using the exposure and reading pattern for reducing distortion so as to output multiple low resolution images, and to generate the output image based on the multiple low resolution images.

(User's Operation of Switching)

In addition, it is possible to adopt a structure in which user's operation enables setting to perform or not to perform the exposure and reading for reducing distortion, and to switch or not to switch to the ordinary exposure and reading.

(Response to Invalid Frame Generated by Switching Exposure and Reading Pattern)

When a driving method of the pixel portion 24 from the ordinary exposure and reading pattern to the exposure and reading pattern for reducing distortion or in the opposite direction, an invalid image (hereinafter referred to as an invalid frame, and the image output from the pixel portion 24 is referred to as a frame) may be generated. The invalid frame means a frame in which a valid received light pixel signal can not be obtained temporarily from the pixel portion 24 when the driving method is switched. In accordance with characteristics of the pixel portion 24, there are a case where the invalid frame is generated and a case where the invalid frame is not generated.

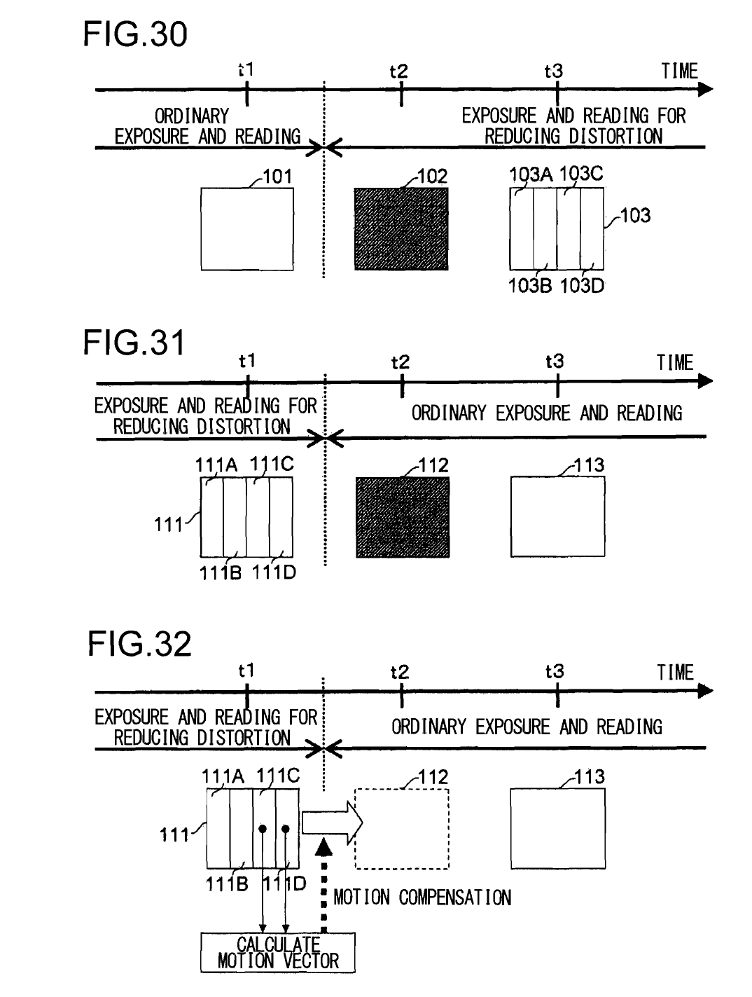

FIGS. 30 and 31 illustrate image diagrams of frame sequence output from the pixel portion 24 every frame period (t1, t2, t3, and so on). FIG. 30 illustrates a frame sequence output when the ordinary exposure and reading pattern is switched to the exposure and reading pattern for reducing distortion between time points t1 and t2. FIG. 31 illustrates a frame sequence output when the exposure and reading pattern for reducing distortion is switched to the ordinary exposure and reading pattern. In FIGS. 30 and 31, originally at the timing of time point t2, the frame by the exposure and reading for reducing distortion and the frame by the ordinary exposure and reading should be output respectively. However, because a certain period is necessary for switching the driving method, the valid received light pixel signal cannot be obtained from the pixel portion 24. As a result, invalid frames 102 and 112 are output.

If such the invalid frames exist, unpleasant feeling may be given to a viewer of the taken image. Therefore, a certain countermeasure is necessary. As a first countermeasure for the invalid frame, there is a method in which at the timing of generating the invalid frame, the frame generated just before the timing is replaced with the invalid frame so as to output the result. In FIG. 30, the invalid frame 102 output at the time point t2 can be replaced with an ordinary exposure and reading frame 101 output at time point t1 just before the time point t2. In addition, in FIG. 31, the invalid frame 112 can be replaced with a combined frame 111 obtained by combining four low resolution frames 111A, 111B, 111C, and 111D output by the exposure and reading for reducing distortion. Note that combining of the low resolution frames is performed by the method described in the second example.

At the time point t2 when the invalid frame is generated, if the frame generated at the time point t3 just after the time point t2 can be used, the frame may be replaced with the invalid frame. Alternatively, a frame to be an average of the frames generated at the time points t1 and t3 just before and after the time point t2 when the invalid frame is generated may be replaced with the invalid frame. In other words, in FIG. 30, the invalid frame 102 output at the time point t2 can be replaced with a combined frame 103 generated by combining four low resolution frames 103A, 103B, 103C, and 103D output by the exposure and reading for reducing distortion output at the time point t3 just after the time point t2, or with a frame to be an average of the frames 101 and 103. In FIG. 31, the invalid frame 112 can be replaced with a frame 113 output by the ordinary exposure and reading, or with a frame to be an average of the frames 111 and 113.

FIG. 32 illustrates a frame sequence output when the exposure and reading pattern for reducing distortion is switched to the ordinary exposure and reading pattern between the time points t1 and t2, similarly to FIG. 31. Note that in FIGS. 31 and 32, the low resolution frames are output in order of frames 111A, 111B, 111C, and 111D from the pixel portion 24 by the exposure and reading for reducing distortion. In FIG. 32, a second countermeasure for the invalid frame is a method in which among the low resolution frame 111A, 111B, 111C, and 111D output by the exposure and reading for reducing distortion at the time point t1, a motion vector between the frames 111C and 111D output at time points closer to the time point t2 when the invalid frame is generated is calculated, and a frame in which position correction in the horizontal direction (hereinafter referred to as motion compensation) is performed on the combined frame 111 using the motion vector is replaced with the invalid frame generated at the time point t2 so as to output the result. Thus, for example, when panning is being performed, it is possible to output a frame considering movement of the subject due to the panning at the time point t2. As a result, the frame sequence output successively at the time point t1, t2, and t3 has little incompatibility and can be viewed as a more natural image.

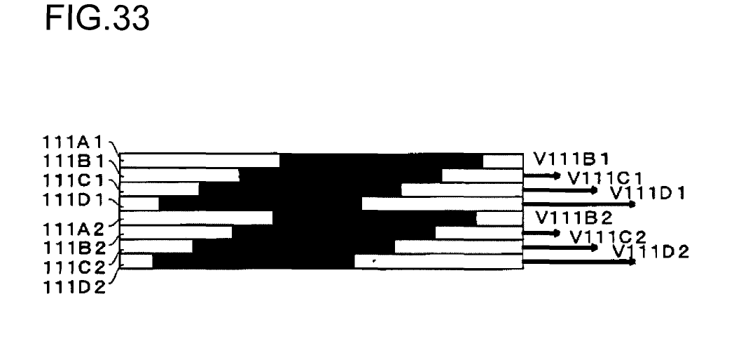

FIG. 33 illustrates eight pixel rows included in the combined image 111 and is a diagram corresponding to FIG. 11 of the second example. In FIG. 33, motion vectors V111B1, V111C1, and V111D1 express motion vectors of pixel rows 111B1, 111C1, and 111D1, respectively, in the case where pixel row 111A1 of the frame 111A is a reference. Similarly, motion vectors V111B2, V111C2, and V111D2 express motion vectors of pixel rows 111B2, 111C2, and 111D2, respectively, in the case where pixel row 111A2 of the frame 111A is a reference. Note that the motion vectors correspond to distortions in the horizontal direction between pixel rows in FIG. 11 of the second example. When the number of pixel rows of the low resolution frame 111A, 111C, and 111D is N, the motion vector V111C of the frame 111C with reference to the frame 111A is calculated by the following equation (7a), and the motion vector V111D of the frame 111D with reference to the frame 111A is calculated by the following equation (7b). A motion vector V111DC between the frames 111C and 111D is calculated by the following equation (7c). Here, because the motion vector V111DC is a motion vector of ¼ frame period, a reverse motion vector MCV112 of four times is calculated by the following equation (7d). Then, using the reverse motion vector MCV112, motion compensation of the combined frame 111 is performed so as to replace with the invalid frame 112.

$$\begin{matrix}[ Expression 7 ] & \\ V 111 C = {\sum }_{n = 1}^{N} V 111 Cn / N & ( 7 a ) \\ V 111 D = {\sum }_{n = 1}^{N} V 111 Dn / N & ( 7 b ) \\ V 111 DC = V 111 D - V 111 C & ( 7 c ) \\ MCV 112 = - 4 \times V 111 DC & ( 7 d )\end{matrix}$$

In FIG. 30, at the time point t2 when the invalid frame is generated, if the combined frame 103 generated at the time point t3 just after the time point t2 can be used, it is possible to perform motion compensation of the combined frame 103 using the motion vector calculated from the frames 103A and 103B closer to the time point t2, so as to replace with the invalid frame 102. Alternatively, it is possible to replace a frame to be an average of the frames in which motion compensation is performed on the combined frame by the exposure and reading for reducing distortion generated just before and after the time point t2 and the ordinary exposure and reading frame with the invalid frame. Note that in FIG. 30, the low resolution frames are output in order of the frames 103A, 103B, 103C, and 103D from the pixel portion 24 by the exposure and reading for reducing distortion.

As described above, there is exemplified the case where various exposure and reading patterns for reducing distortion are applied to the imaging portion 24 of the single sensor and Bayer arrangement type (see FIGS. 3, 17, and 23), but the type of the usable imaging portion 24 is not limited to the single sensor and Bayer arrangement type. For instance, the various exposure and reading patterns for reducing distortion may be applied to an imaging portion of the single sensor and an arrangement other than the Bayer arrangement, or to an imaging portion having a plurality of image pickup elements such as a three-sensor type (for example, R, G, and B pixel signals are generated separately using three image sensors).

When the various exposure and reading patterns for reducing distortion are applied to the imaging portion having a plurality of image pickup elements, the individual image pickup elements may adopt different exposure and reading patterns for reducing distortion or may adopt the same exposure and reading pattern for reducing distortion. If the same exposure and reading pattern for reducing distortion is adopted and the exposure and reading is performed at the same timing, it is possible to prevent the signals constituting the pixels obtained from image pickup elements from being exposed and read at different timings. In addition, it is possible to perform the above-mentioned combining of the second example separately for each of the image pickup elements, or to perform the above-mentioned combining of the second example integrally after combining the pixel signals obtained from the image pickup elements. If the combining is performed integrally, it is possible to a deviation or the like that might occur due to different suppress combining methods.

In addition, as to the image pickup device 1 according to the embodiment of the present invention, it is possible to adopt a structure in which actions of the image processing portion 5 and the scan control portion 21 are performed by a controller unit such as a microcomputer. Further, a part or a whole of the functions realized by the controller unit may be described as a program, which is executed by a program executing device (for example, a computer) so that a whole or a part of the functions are realized.

In addition, without limiting to the above-mentioned case, the image pickup device 1 illustrated in FIGS. 1, 2, and 9 can be realized by hardware or by combination of hardware and software. In addition, when a part of the image pickup device 1 is constituted using software, the block diagram of the part constituted of software indicates a functional block diagram of the part.

Although the embodiment of the present invention is described above, the present invention is not limited to this embodiment, which can be modified variously within the scope of the spirit of the invention without deviating from the same.

### INDUSTRIAL APPLICABILITY

The present invention relates to an image pickup device having an XY address type image pickup element.

### EXPLANATION OF NUMERALS

2 image sensor
21 scan control portion
22 vertical scan portion
23 horizontal scan portion
24 pixel portion
25 output portion
5 image processing portion
51 signal processing portion
52 memory control portion
53 motion detection portion

1. An image pickup device comprising:
an image pickup element that can perform exposure and reading by designating arranged arbitrary pixels;
a scan control portion that controls exposure and reading of pixels of the image pickup element; and
a signal processing portion that generates an output image, wherein
the scan control portion performs the exposure and reading discontinuously on pixels arranged in a predetermined direction of the image pickup element so as to generate a low resolution image, and
the signal processing portion generates the output image based on the low resolution image.

2. The image pickup device according to claim 1, wherein
the scan control portion performs the exposure and reading of pixels by sequentially switching a plurality of pixel groups having different pixel positions so as to sequentially generate a plurality of low resolution images, and
the signal processing portion generates one output image based on the plurality of low resolution images.

3. The image pickup device according to claim 1, further comprising a lens portion having a variable zoom magnification, wherein
the scan control portion determines positions of pixels to be exposed and read for generating the low resolution image in accordance with the zoom magnification of the lens portion.

4. The image pickup device according to claim 1, further comprising:
a memory that temporarily store a plurality of low resolution images; and
a memory control portion that controls reading of the low resolution images from the memory to the signal processing portion, wherein
the memory control portion sets an order of reading pixel signals of the low resolution images stored in the memory to be correspond to a pixel arrangement of the image pickup element from which the pixel signal are obtained.

5. The image pickup device according to claim 1, further comprising a motion detection portion that detects a motion among a plurality of low resolution images by comparing the plurality of low resolution images, wherein
the signal processing portion corrects relative positional relationship among the plurality of low resolution images for combining so that the motion detected by the motion detection portion becomes small, so as to generate the output image.

6. An image pickup device comprising:
an image pickup element that can perform exposure and reading by designating arranged arbitrary pixels;
a scan control portion that controls exposure and reading of pixels of the image pickup element;
a signal processing portion that generates an output image; and
a lens portion having a variable zoom magnification, wherein
when the zoom magnification is a predetermined value or larger, the scan control portion performs the exposure and reading discontinuously on pixels arranged in a predetermined direction of the image pickup element so as to generate a low resolution image, and the signal processing portion generates the output image based on the low resolution image, and
when the zoom magnification is smaller than the predetermined value, the scan control portion performs the exposure and reading continuously on the pixels arranged in the predetermined direction of the image pickup element so as to generate an ordinary image, and the signal processing portion generates the output image based on the ordinary image.

7. An image pickup device comprising:
an image pickup element that can perform exposure and reading by designating arranged arbitrary pixels;
a scan control portion that controls exposure and reading of pixels of the image pickup element; and
a signal processing portion that generates an output image; and
a shake correcting portion, wherein
when the shake correction is enabled, the scan control portion performs the exposure and reading discontinuously on pixels arranged in a predetermined direction of the image pickup element so as to generate a low resolution image, and the signal processing portion generates the output image based on the low resolution image, and
when the shake correction is disabled, the scan control portion performs the exposure and reading continuously on the pixels arranged in the predetermined direction of the image pickup element so as to generate an ordinary image, and the signal processing portion generates the output image based on the ordinary image.

8. The image pickup device according to claim 6, wherein if an invalid image is generated when an exposure and reading pattern for the image pickup element is switched, using a motion vector generated between low resolution images output just before and after generation of the invalid image, motion compensation is performed on the output image based on the low resolution images output just before or after, and the generated image replaces the invalid image.

9. The image pickup device according to claim 7, wherein if an invalid image is generated when an exposure and reading pattern for the image pickup element is switched, using a motion vector generated between low resolution images output just before and after generation of the invalid image, motion compensation is performed on the output image based on the low resolution images output just before or after, and the generated image replaces the invalid image.

10. The image pickup device according to claim 2, further comprising a lens portion having a variable zoom magnification, wherein
the scan control portion determines positions of pixels to be exposed and read for generating the low resolution image in accordance with the zoom magnification of the lens portion.

11. The image pickup device according to claim 2, further comprising:
a memory that temporarily store a plurality of low resolution images; and
a memory control portion that controls reading of the low resolution images from the memory to the signal processing portion, wherein
the memory control portion sets an order of reading pixel signals of the low resolution images stored in the memory to be correspond to a pixel arrangement of the image pickup element from which the pixel signal are obtained.

12. The image pickup device according to claim 3, further comprising:
a memory that temporarily store a plurality of low resolution images; and
a memory control portion that controls reading of the low resolution images from the memory to the signal processing portion, wherein
the memory control portion sets an order of reading pixel signals of the low resolution images stored in the memory to be correspond to a pixel arrangement of the image pickup element from which the pixel signal are obtained.

13. The image pickup device according to claim 2, further comprising a motion detection portion that detects a motion among a plurality of low resolution images by comparing the plurality of low resolution images, wherein
the signal processing portion corrects relative positional relationship among the plurality of low resolution images for combining so that the motion detected by the motion detection portion becomes small, so as to generate the output image.

14. The image pickup device according to claim 3, further comprising a motion detection portion that detects a motion among a plurality of low resolution images by comparing the plurality of low resolution images, wherein
the signal processing portion corrects relative positional relationship among the plurality of low resolution images for combining so that the motion detected by the motion detection portion becomes small, so as to generate the output image.

15. The image pickup device according to claim 4, further comprising a motion detection portion that detects a motion among a plurality of low resolution images by comparing the plurality of low resolution images, wherein
the signal processing portion corrects relative positional relationship among the plurality of low resolution images for combining so that the motion detected by the motion detection portion becomes small, so as to generate the output image.

16. The image pickup device according to claim 7, wherein if an invalid image is generated when an exposure and reading pattern for the image pickup element is switched, using a motion vector generated between low resolution images output just before and after generation of the invalid image, motion compensation is performed on the output image based on the low resolution images output just before or after, and the generated image replaces the invalid image.
